(19) United States
(12) Patent Application Publication
(10) Pub. No.: US 2026/0320413 A1
(43) Pub. Date: Oct. 15, 2026

(54) MACHINE LEARNING SYSTEM WITH MODALITY SELECTION MODEL

(71) Applicant: Microsoft Technology Licensing, LLC, Redmond, WA (US)

(72) Inventors: Marc A. GOODNER, Kirkland, WA (US); Brian Scott KRABACH, Snohomish, WA (US)

(73) Assignee: Microsoft Technology Licensing, LLC, Redmond, WA (US)

(21) Appl. No.: 19/174,838

(22) Filed: Apr. 9, 2025

(51) Int. Cl. G06N 3/10; G06N 3/0475

(52) U.S. Cl. CPC G06N 3/10; G06N 3/0475

(57) ABSTRACT

A computing system including one or more input devices, output devices, and processing devices. The one or more processing devices receive a user input via an input device and receive interaction context metadata associated with the user input. The interaction context metadata includes an input modality of the user input and output modalities of the one or more output devices. At a multimodal machine learning (ML) system, the one or more processing devices select one or more of the output modalities at a modality selection ML model based at least on the user input and the interaction context metadata. At one or more generative ML models, based at least on the user input, the one or more processing devices compute one or more respective model outputs that respectively have the one or more selected output modalities. The one or more processing devices output the one or more model outputs.

### BACKGROUND

Recent advances in machine learning (ML) have included the development of ML models that are capable of utilizing multiple different input and/or output modalities. For example, a multimodal ML model may be configured to receive text inputs and produce outputs that include text, images, or a combination of both. As another example, a multimodal ML model may be configured to receive inputs in either text form or audio form and to produce text or audio outputs.

ML models may also be included in systems of multiple ML models that are configured to handle different input and/or output modalities, thereby forming a multimodal ML system. Each of the ML models included in the multimodal ML system may have unimodal or multimodal inputs and/or outputs. In addition to the ML models, the multimodal ML system includes scaffolding code that specifies conditions under which the different ML models are executed. Thus, the scaffolding code may be executed to select which ML models are executed in different circumstances. The scaffolding code may further include input preprocessing and/or output postprocessing operations that are performed in addition to ML model execution.

### SUMMARY

According to one aspect of the present disclosure, a computing system is provided, including one or more input devices, one or more output devices, and one or more processing devices. The one or more processing devices are configured to receive a user input via an input device of the one or more input devices. The one or more processing devices are further configured to receive interaction context metadata associated with the user input. The interaction context metadata includes an input modality of the user input and a plurality of output modalities of the one or more output devices. At a multimodal machine learning (ML) system, the one or more processing devices are further configured to select one or more of the output modalities at a modality selection ML model based at least in part on the user input and the interaction context metadata. At one or more generative ML models, based at least in part on the user input, the one or more processing devices are further configured to compute one or more respective model outputs that respectively have the one or more selected output modalities. The one or more processing devices are further configured to output the one or more model outputs.

According to another aspect of the present disclosure, a computing system is provided, including one or more processing devices configured to receive a first user input at a user interface of a machine learning (ML) system. In response to receiving the first user input, the one or more processing devices are further configured to initiate a first model call to a first ML model included in the ML system. During execution of the first model call, the one or more processing devices are further configured to receive one or more second user inputs. The one or more processing devices are further configured to perform one or more second model calls to a second ML model included in the ML system to compute one or more second model outputs based at least in part on the one or more second user inputs. The one or more processing devices are further configured to output the one or more second model outputs to the user interface. Subsequently to outputting the one or more second model outputs, the one or more processing devices are further configured to receive a first model output computed at the first ML model in response to receiving the first user input. The one or more processing devices are further configured to output the first model output to the user interface.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a computing system at which a multimodal machine learning (ML) system is instantiated, according to one example embodiment.

FIG. 2 schematically shows the computing system when the one or more processing devices receive a user input at a user interface and process the input at the multimodal ML system, according to the example of FIG. 1.

FIG. 3A schematically shows the computing system when a modality selection ML model is configured to select one or more modality indicator prompt fragments, according to the example of FIG. 2.

FIG. 3B schematically shows the computing system when the modality selection ML model is configured to select one or more generative ML models, according to the example of FIG. 2.

FIG. 3C schematically shows the computing system when the modality selection ML model is configured to select one or more output detail levels of one or more model outputs, according to the example of FIG. 2.

FIG. 4 schematically shows the computing system in an example in which a plurality of model outputs are stored in an output queue, according to the example of FIG. 2.

FIG. 5A schematically shows the computing system in an example in which the model outputs are stored in device-specific output queues, according to the example of FIG. 4.

FIG. 5B schematically shows the computing system in an example in which the model outputs are stored in modality-specific output queues, according to the example of FIG. 4.

FIG. 6 schematically shows the computing system in an example in which a model output is updated to reflect a change in interaction context metadata, according to the example of FIG. 4.

FIG. 7 schematically shows the computing system during training of the modality selection ML model, according to the example of FIG. 2.

FIG. 8A shows a flowchart of a method for use with a computing system to perform output modality selection at a multimodal ML system, according to the example of FIG. 1.

FIGS. 8B-8E show additional steps of the method of FIG. 8A that may be performed in some examples.

FIG. 9 schematically shows the computing system when a plurality of asynchronous sets of conversational turns are exchanged with over the user interface, according to the example of FIG. 1.

FIGS. 10A-10B schematically show the user interface and the multimodal ML system in examples in which the one or more processing devices are further configured to receive a third user input and generate a third model output, according to the example of FIG. 9.

FIG. 11 schematically shows the computing system in an example in which a first ML model is executed at a first server and a second ML model is executed at a second server, according to the example of FIG. 9.

FIG. 12 schematically shows the computing system in an example in which one or more intermediate results of the first model call are transmitted to the user interface prior to transmitting the first model output, according to the example of FIG. 9.

FIGS. 13A-13B schematically show the multimodal ML system when context protocol sessions are executed at the central router, according to the example of FIG. 9.

FIG. 14 schematically shows the computing system in an example in which a modality-specific output queue is stored in memory, according to the example of FIG. 9.

FIG. 15A shows a flowchart of an example method for use with a computing system exchange a plurality of asynchronous sets of conversational turns with a respective plurality ML models, according to the example of FIG. 9.

FIGS. 15B-15F show additional steps of the method of FIG. 15A that may be performed in some examples.

FIG. 16 shows a schematic view of an example computing environment in which the computing system of FIG. 1 may be instantiated.

### DETAILED DESCRIPTION

When users interact with existing multimodal ML systems, those users typically have to explicitly select which output modality is utilized. For example, the user may select an output modality from a menu included in the user interface. In other examples, the user may include output modality information in a prompt that the user enters into a language model, using a prompt fragment such as “generate an image” or “display your response and read it aloud.” Having to specify the output type may interrupt the user experience of interacting with the ML system. In some examples, a user of a multimodal ML system also has to specify an input type. The multimodal ML system may, for example, have text as a default input type, and may require the user to select another input type from a menu in order to process that input type at the multimodal ML system.

Existing multimodal ML systems also have difficulty adjusting to changes in the setting in which user interaction takes place. For example, a user may begin an interaction session using spoken user input (e.g., in a use case scenario in which the user's hands are occupied with some other task). The multimodal ML system may produce audio outputs in response to the user's audio inputs. However, if the user switches to entering text inputs at a graphical user interface (GUI), an existing multimodal ML system may continue presenting outputs to the user in the audio format, even if audio responses are no longer as convenient for the user as other output modalities. Existing multimodal ML systems are unable to programmatically adapt to such changes in interaction context. Thus, the user of an existing multimodal ML system would have to explicitly specify an intended change in output modality.

The inputs and outputs of existing multimodal ML systems typically follow a static input-output flow in which the multimodal ML system outputs one response to the user interface following each user input. This static pattern may introduce delays into user interactions when the user prompts the multimodal ML system to perform a task with a long runtime. For example, a reasoning model (a generative language model trained to natively follow a chain-of-thought structure in its outputs) may have a significantly longer inferencing time compared to other types of machine learning models included in the multimodal ML system. The user may be unable to perform other tasks at the multimodal ML system while waiting to receive the inferencing output from the reasoning model. Use of other tools or resources by the multimodal ML system in addition to ML models may introduce further delays, such as in examples in which the multimodal ML system performs a database search or an Internet search.

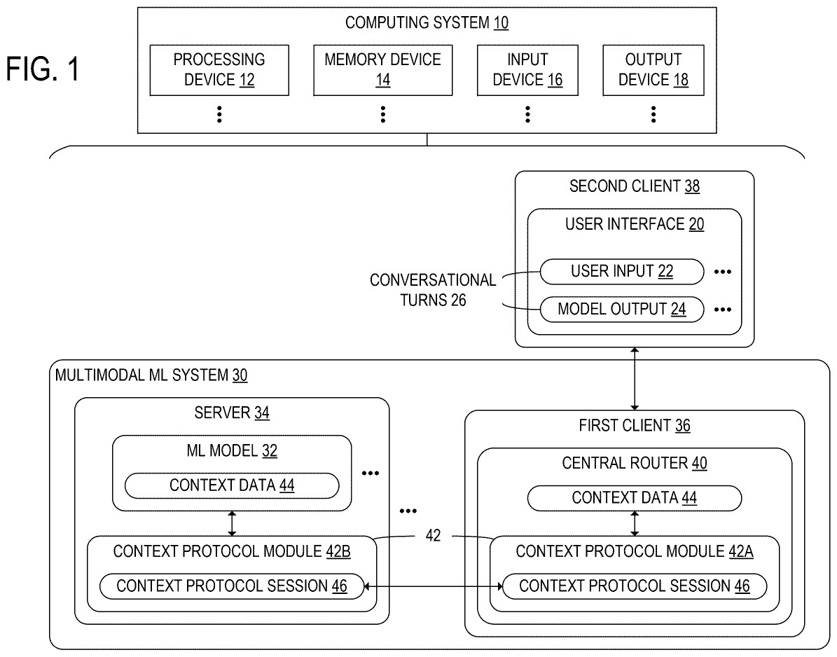

In order to address the above challenges, the present disclosure provides a computing system 10 at which a multimodal ML system 30 is implemented, as schematically depicted in the example of FIG. 1. The computing system 10 includes one or more processing devices 12 and one or more memory devices 14. The one or more processing devices 12 may, for example, include one or more central processing units (CPUs), graphics processing units (GPUs), neural processing units (NPUs), and/or other types of hardware accelerators. The one or more memory devices 14 may, for example, include one or more volatile memory devices and one or more non-volatile storage devices.

The computing system 10 further includes one or more input devices 16 and one or more output devices 18. For example, the one or more input devices 16 may include a touchscreen, a keyboard, a mouse, a microphone, a camera, an accelerometer, and/or one or more other types of input devices. The one or more output devices 18 may, for example, include a display, a speaker, a haptic feedback device, and/or one or more other types of output devices.

The one or more processing devices 12 included in the computing system 10 are configured to execute a user interface 20 via which a user interacts with the multimodal ML system 30 using the one or more input devices 16 and the one or more output devices 18. Over the user interface 20, the one or more processing devices 12 are configured to exchange conversational turns 26 between the user and the multimodal ML system 30. Each of the conversational turns 26 may be a user input 22 or a model output 24. The user inputs 22 may, for example, be text, image, or speech inputs. The model outputs 24 may, for example, be displayed text, displayed image, or audio outputs.

The multimodal ML system 30 includes a plurality of ML models 32. For example, the multimodal ML system 30 may include a plurality of domain expert ML models 32 that are specialized for processing inputs in different subject matter domains (e.g., programming, medicine, mathematics, or agriculture). The plurality of ML models 32 may also differ in their input and/or output modalities. In addition, the multimodal ML system 30 includes a central router 40 that is configured to control transmission of inputs and outputs to the ML models 32. The central router 40 may include scaffolding code of the multimodal ML system 30 and may additionally include one or more of the ML models 32, as discussed in further detail below.

In some examples, the multimodal ML system 30 may have a server-client configuration. In the example of FIG. 1, one or more of the ML models 32 are executed at one or more servers 34, whereas the central router 40 is executed at a first client 36. The user interface 20 may be executed at a second client 38. Alternatively, the user interface 20 and the central router 40 may be executed at a shared client. The one or more servers 34 and the first client 36 may be physical server and client computing devices that are connected over a network. Alternatively, the one or more servers 34 and/or the first client 36 may be virtual computing devices.

The first client 36 and the one or more servers 34 shown in the example of FIG. 1 may be configured to communicate using a context protocol. For example, the context protocol may be Model Context Protocol (MCP). In the example of FIG. 1, the first client 36 and the one or more servers 34 are each configured to execute context protocol modules 42 via which the central router 40 and the one or more ML models 32 exchange context data 44. This context data 44 may include the plurality of conversational turns 26 exchanged between the user and the one or more ML models 32. Other model inputs and/or outputs of the one or more ML models 32 may also be included in the context data 44. At the context protocol module 42A of the first client 36 and the context protocol module 42B of the server 34, the one or more processing devices 12 may be configured to instantiate a context protocol session 46 in which the first client 36 and a server 34 exchange the context data 44. The first client 36 may conduct a plurality of concurrent context protocol sessions 46 with different servers 34. Accordingly, the context protocol module may be used to coordinate the context data 44 that is available as inferencing input to the plurality of ML models 32.

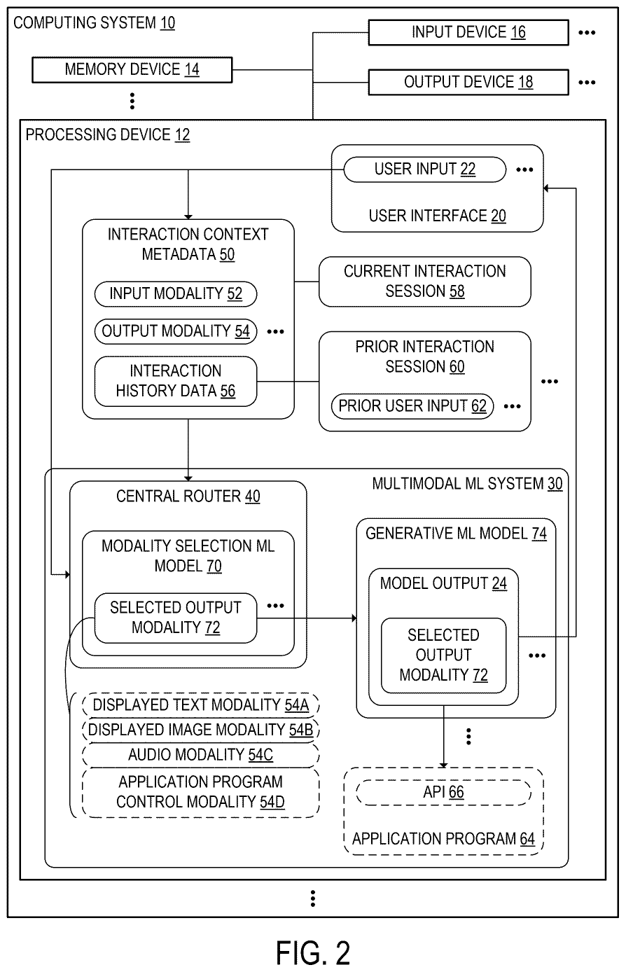

FIG. 2 schematically shows the computing system 10 when the one or more processing devices 12 receive a user input 22 via an input device 16 of the one or more input devices 16. The one or more processing devices 12 are further configured to receive interaction context metadata 50 associated with the user input 22. The interaction context metadata 50 includes information related to a setting in which the user interacts with the multimodal ML system 30 in a current interaction session 58. The current interaction session 58 may, for example, be a communication session between the first client 36 and the second client 38. The interaction context metadata 50 includes an input modality 52 of the user input 22.

The interaction context metadata 50 further includes a plurality of output modalities 54 of the one or more output devices 18. The output modalities 54 may include a displayed text modality 54A, a displayed image modality 54B, and an audio modality 54C. In some examples, the plurality of output modalities 54 may further include an application program control modality 54D. An ML model 32 that outputs in the application program control modality 54D may programmatically generate control instructions to perform an action at another application program 64. For example, the control instructions may include one or more application-programming interface (API) calls to an API 66 of the application program 64.

In some examples, the interaction context metadata 50 may include each of the output modalities 54 of each of the output devices 18. In other examples, the set of output modalities 54 included in the interaction context metadata 50 may omit one or more output modalities 54 that are already in use at the user interface 20 to present other outputs to the user. As an example, the one or more processing devices 12 may be configured to omit the audio modality 54C from the set of output modalities 54 when another computing process is already presenting an audio output to the user via the user interface 20.

The interaction context metadata 50 may further include user interaction history data 56. The user interaction history data 56 may be associated with one or more prior user inputs 62 received at the multimodal ML system 30 in one or more prior interaction sessions 60. The one or more prior interaction sessions 60 may have been conducted between the first client 36 and the second client 38. The one or more prior user inputs 62 may, for example, be one or more text, image, or speech inputs entered at the user interface 20 during the one or more prior interaction sessions 60. The user interaction history data 56 may, for example, include respective input modalities 52 with which the user entered the one or more prior user inputs 62, and may further include one or more output modalities 54 in which the multimodal ML system 30 responded to those prior user inputs 62. The interaction history data 56 may further include one or more output modality selections entered by the user (e.g., in a prompt or a settings menu) in the one or more prior interaction sessions 60.

In examples in which the multimodal ML system 30 includes a first client 36 connected over a context protocol to one or more servers 34, the interaction history data 56 may further include the one or more servers 34 with which the central router 40 had context protocol sessions 46 during the one or more prior interaction sessions 60. Thus, the interaction history data 56 may indicate the one or more ML models 32 available during the one or more prior interaction sessions 60 for model output generation. Additionally or alternatively, in examples in which the application program control modality 54D is available to the multimodal ML system 30 as an output modality, the interaction history data 56 may include respective indications of one or more application programs 64 for which the multimodal ML system 30 generated control instructions in the one or more prior interaction sessions 60.

The one or more processing devices 12 are further configured to convey the user input 22 and the interaction context metadata 50 to the central router 40 executed at the multimodal ML system 30. At the central router 40, the one or more processing devices 12 are configured to execute a modality selection ML model 70. The modality selection ML model 70 is configured to select one or more of the output modalities 72 based at least in part on the user input 22 and the interaction context metadata 50. For example, the modality selection ML model 70 may be a classifier that has been trained to predict the selected output modality 72 from among the plurality of output modalities 54 indicated in the interaction context metadata 50.

The one or more processing devices 12 are further configured to compute one or more respective model outputs 24 at one or more generative ML models 74 included among the plurality of ML models 32. The generative ML models 74 may be executed at the servers 34, as in the example of FIG. 1. The one or more model outputs 24 are computed based at least in part on the user input 22 and have the one or more selected output modalities 72 identified at the modality selection ML model 70. Thus, the modality selection ML model 70 selects the one or more respective output modalities 72 with which the one or more generative ML models 74 compute the one or more model outputs 24.

In some examples, at the modality selection ML model 70, the one or more processing devices 12 may be configured to select two or more of the output modalities 72 from among the plurality of output modalities 54. In such examples, the one or more processing devices 12 may be further configured to concurrently generate two or more model outputs 24 at respective instances of the one or more generative ML models 74. For example, the two or more model outputs 24 may be concurrently generated at different servers 34 and transmitted to the central router 40.

The one or more processing devices 12 are further configured to output the one or more model outputs 24. The one or more model outputs 24 may each be transmitted to at least one output device 18 of the one or more output devices 18 included in the computing system 10. The at least one output device 18, in such examples, is configured to output the one or more selected output modalities 72. In one example, the one or more processing devices 12 may be configured to execute an image generation ML model and a text generation ML model. The one or more processing devices 12 may be further configured to output both the generated image and generated text to a display device. As another example, the one or more processing devices 12 may be configured to execute a text generation ML model and may be further configured to execute a text-to-speech ML model that computes an audio output from the generated text. In this example, the one or more processing devices 12 may be configured to output the generated text to a display device and output the generated audio to a speaker.

In examples in which the one or more selected output modalities 72 include the application program control modality 54D, the one or more processing devices 12 may be configured to output the model output 24 as an API call to an API 66 of the application program 64, rather than as an output transmitted to an output device 18. Thus, control instructions computed at the one or more generative ML models 74 may be used to perform an action at the application program 64.

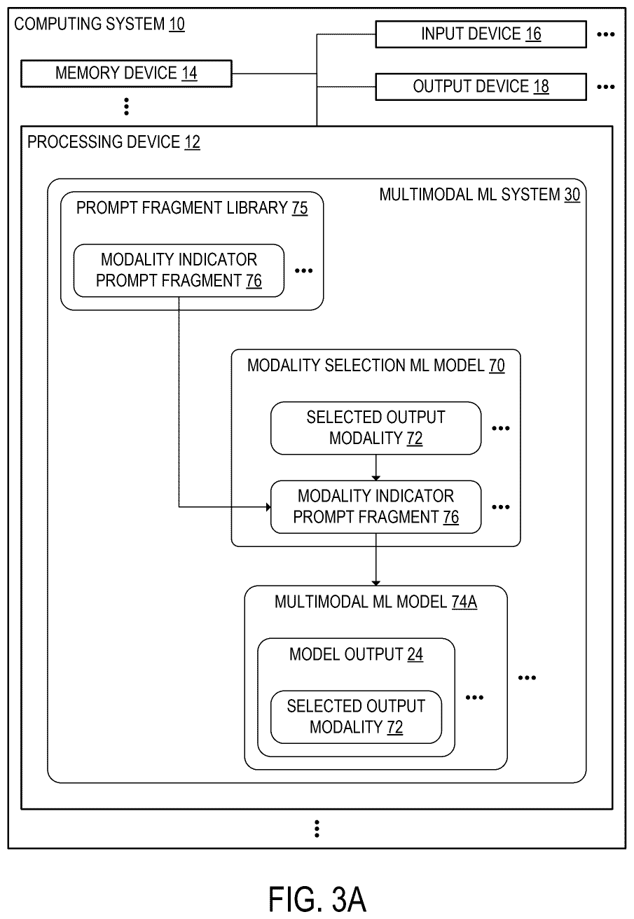

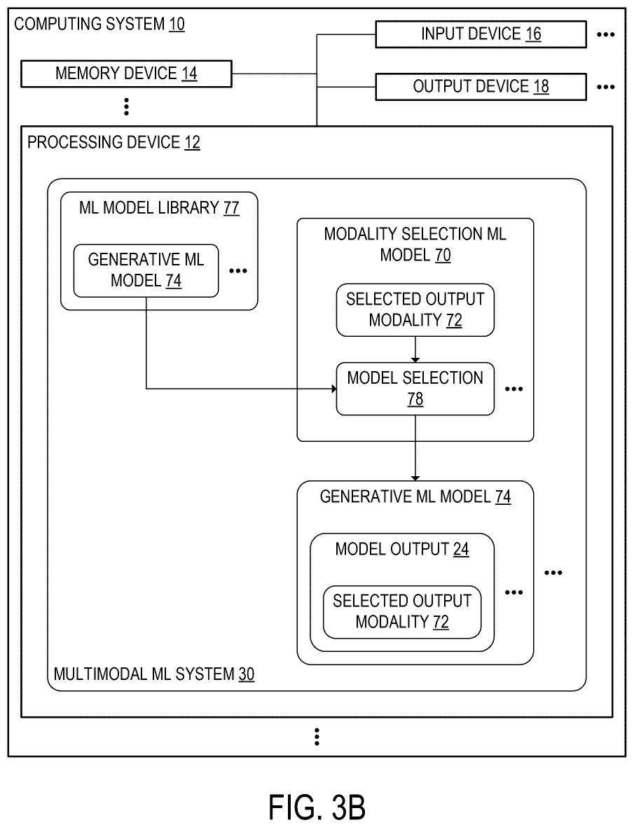

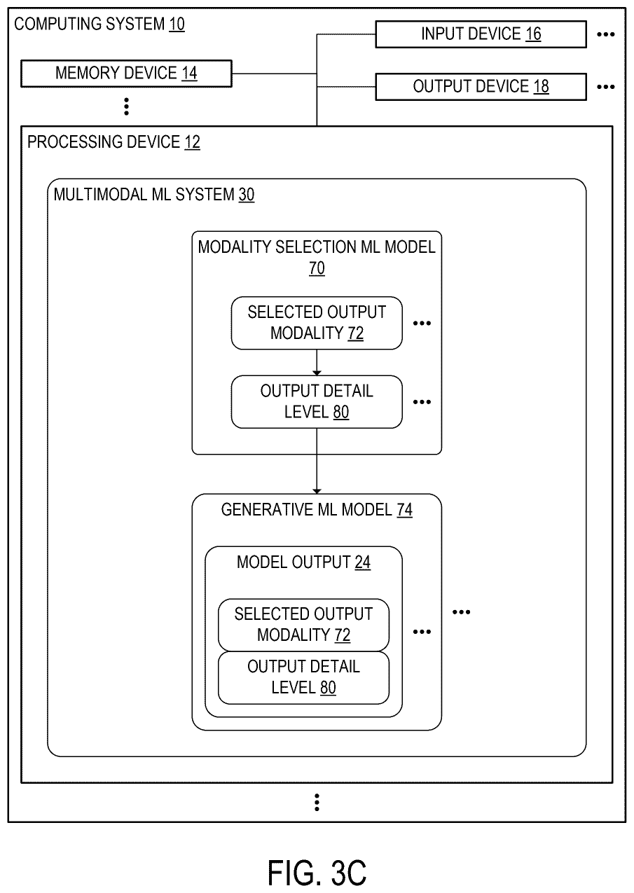

FIGS. 3A-3C schematically shows example types of modality selection model outputs that may be input into the one or more generative ML models 74. As shown in FIG. 3A, in examples in which one or more multimodal ML models 74A are included among the one or more generative ML models 74, the one or more processing devices 12 are configured to compute one or more modality indicator prompt fragments 76 at the modality selection ML model 70. Examples of modality indicator prompt fragments 76 are “Generate your response as an image” and “Compute an API call as an output.” A plurality of the modality indicator prompt fragments 76 may be stored in a prompt fragment library 75. In the example of FIG. 3A, the one or more processing devices 12 are further configured to compute the one or more model outputs 24 at the one or more generative ML models 74 with the one or more selected output modalities 72 respectively specified by the one or more modality indicator prompt fragments 76. Thus, the modality selection ML model 70 is configured to preprocess the user input 22 by inserting a modality indicator prompt fragment 76 that guides the modality of ML model inferencing.

FIG. 3B schematically shows the computing system 10 in an example in which, at the modality selection ML model 70, the one or more processing devices 12 are configured to select the one or more generative ML models 74 from among a plurality of generative ML models 74. The modality selection ML model 70 is configured to compute a model selection 78 in this example. As shown in FIG. 3B, the model selection 78 may be a selection of a generative ML model 74 from among a plurality of different generative ML models 74 stored in an ML model library 77. These generative ML models 74 may differ in their output modalities 54. Thus, the modality selection ML model 70 may determine the respective modalities of the one or more model outputs 24 by selecting the generative ML models 74 at which those one or more model outputs 24 are computed.

FIG. 3C schematically shows the computing system 10 in an example in which the one or more processing devices 12 are further configured to compute one or more output detail levels 80 at the modality selection ML model 70. The one or more output detail levels are respectively associated with the one or more selected output modalities 72. At the one or more generative ML models 74, the one or more processing devices 12 are further configured to compute the one or more model outputs 24 with the one or more respective output detail levels 80. For example, the one or more processing devices 12 may be configured to select an output detail level that indicates a low level of detail for a model output generated with the audio modality 54C, but select an output detail level that indicates a high level of detail for a model output that is generated with the displayed text modality 54A and is presented to the user concurrently with the audio output. The one or more processing devices 12 may accordingly present an output in a first output modality as a summary of an output in a second output modality. In some examples, the output detail level 80 specifies a length of the model output 24 (e.g., in terms of duration or number of tokens).

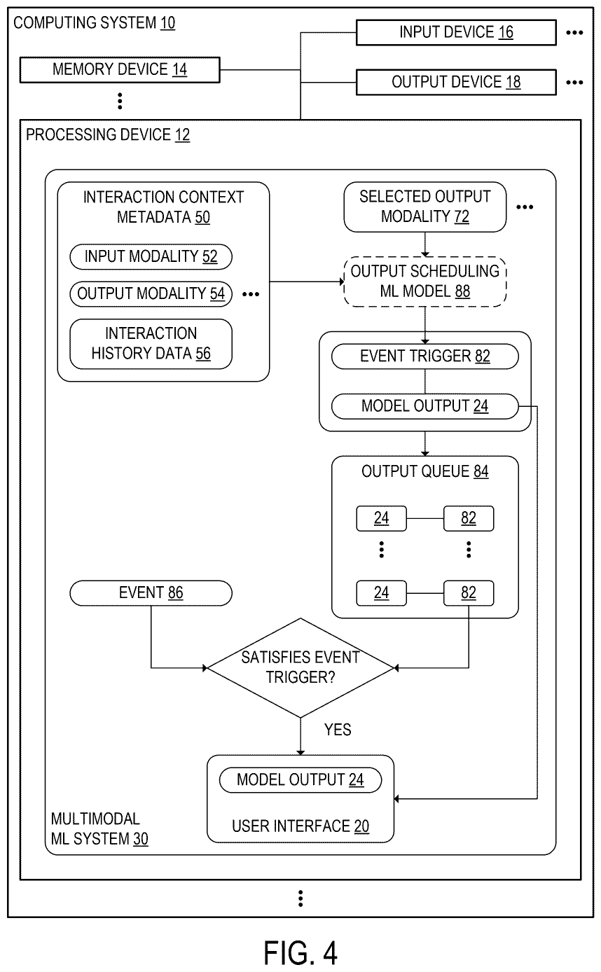

FIG. 4 schematically shows the computing system 10 in an example in which the one or more processing devices 12 are further configured to perform event scheduling for the one or more model outputs 24. In a conventional ML system, the model outputs generated at an ML model are output to the user as soon as those model outputs have been computed and post-processed. However, when the model outputs are immediately output to the user of a conventional ML system, those model outputs may be presented using an output modality or device that the user does not prefer. For example, the user input may specify an audio output when a speaker connected to the ML system is already in use.

In order to present the model output 24 to the user with a desired output modality 54 or output device 18, the one or more processing devices 12 may be configured to implement an output queue 84, as shown in the example of FIG. 4. In this example, based at least in part on the interaction context metadata 50 and the one or more selected output modalities 72, the one or more processing devices 12 are further configured to compute an event trigger 82 associated with a model output 24 of the one or more model outputs 24. For example, the set of available output modalities 54 of the output devices 18 coupled to the multimodal ML system 30 may be used as an input to the computation of the event trigger 82. The one or more processing devices 12 are further configured to store the model output 24 and the event trigger 82 in the output queue 84.

In some examples, as shown in FIG. 4, the one or more processing devices 12 are configured to compute the event trigger 82 at an output scheduling ML model 88 included in the multimodal ML system 30. For example, the output scheduling ML model 88 may be a trained classifier that is configured to receive the selected output modality 72 and at least a portion of the interaction context metadata 50 as input. The output scheduling ML model 88 may be further configured to select a specific output device 18 to indicate in the event trigger 82. As another example, the output scheduling ML model 88 may be configured to compute some other property of the event trigger 82, such as a predetermined time at which the one or more processing devices 12 are configured to output the model output 24 to the user interface 20.

Subsequently to storing the event trigger 82 in the output queue 84, the one or more processing devices 12 may be further configured to determine that the event trigger 82 is satisfied. The one or more processing devices 12 may be configured to make this determination in response to an event 86 of a specified type (e.g., a change in available output devices 18) occurring at the multimodal ML system 30. The one or more processing devices 12 may be further configured to output the model output 24 in response to determining that the event trigger 82 is satisfied. As discussed above, the event trigger 82 may be satisfied when a specific output device 18 or output modality 54 becomes available. In such examples, the event trigger 82 may be satisfied when an output device 18 with a selected output modality 72 becomes coupled to the multimodal ML system 30, or when an already-connected output device 18 is no longer being used to present another model output 24 to the user. In examples in which multiple model outputs 24 have respective event triggers 82 that indicate the same output device 18, the one or more processing devices 12 may be configured to present those model outputs 24 to the user interface 20 in a first-in-first-out manner.

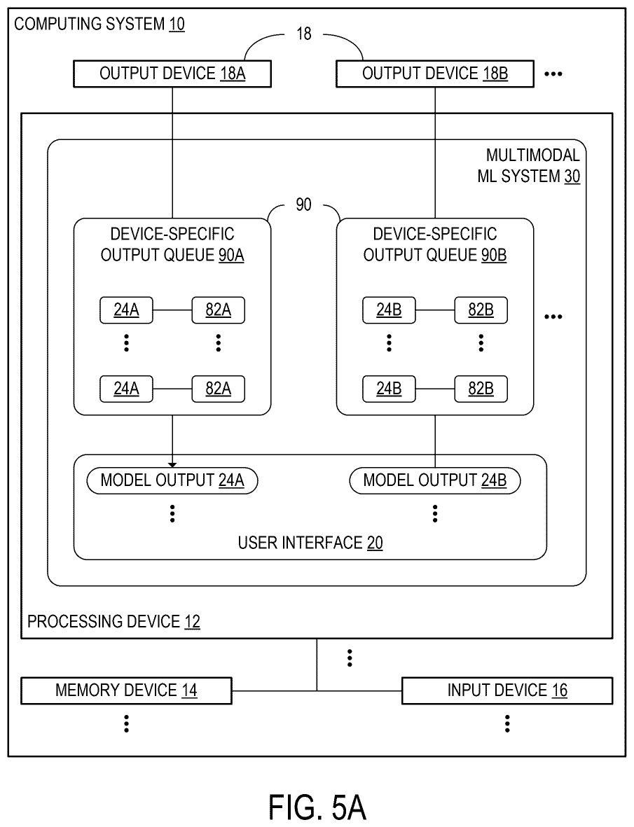

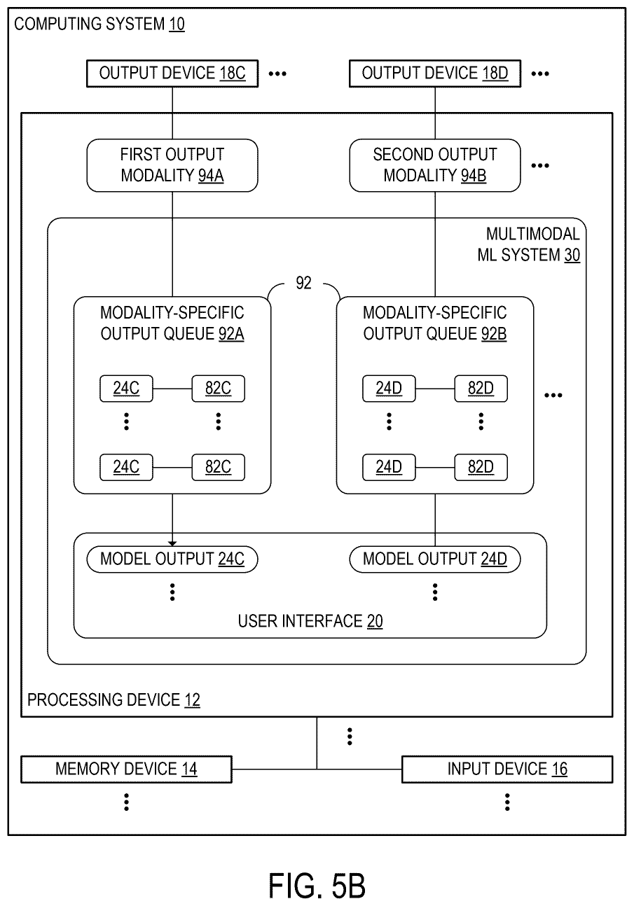

FIGS. 5A-5B schematically show the computing system 10 in examples in which the one or more processing devices 12 are configured to implement a plurality of different output queues 84. In the example of FIG. 5A, the computing system 10 includes a plurality of output devices 18. Output devices 18A and 18B are shown in this example. In addition, the output queue 84 is included among a plurality of device-specific output queues 90 respectively associated with the output devices 18. FIG. 5A shows a device-specific output queue 90A that is associated with the output device 18A and a device-specific output queue 90B that is associated with the output device 18B. The device-specific output queue 90A stores one or more model outputs 24A with respective event triggers 82A, and the device-specific output queue 90B stores one or more model outputs 24B with respective event triggers 82B. Thus, the one or more processing devices 12 may be configured to separately track the availability of the different output devices 18 in order to perform output scheduling for the multimodal ML system 30.

FIG. 5B schematically shows the computing system 10 in an example in which the output queue 84 is included among a plurality of modality-specific output queues 92 respectively associated with the plurality of output modalities 54. In the example of FIG. 5B, one or more output devices 18C are configured to present outputs in a first output modality 94A, and one or more output devices 18D are configured to present outputs in a second output modality 94B. The first output modality 94A has a modality-specific output queue 92A, and the second output modality 94B has a modality-specific output queue 92B. The modality-specific output queue 92A is configured to store one or more model outputs 24C with corresponding event triggers 82C, and the modality-specific output queue 92B is configured to store one or more model outputs 24D with corresponding event triggers 82D. Thus, the one or more processing devices 12 may be configured to maintain separate output queues for model outputs 24 that have shared output modalities and that may therefore have similar event triggers 82.

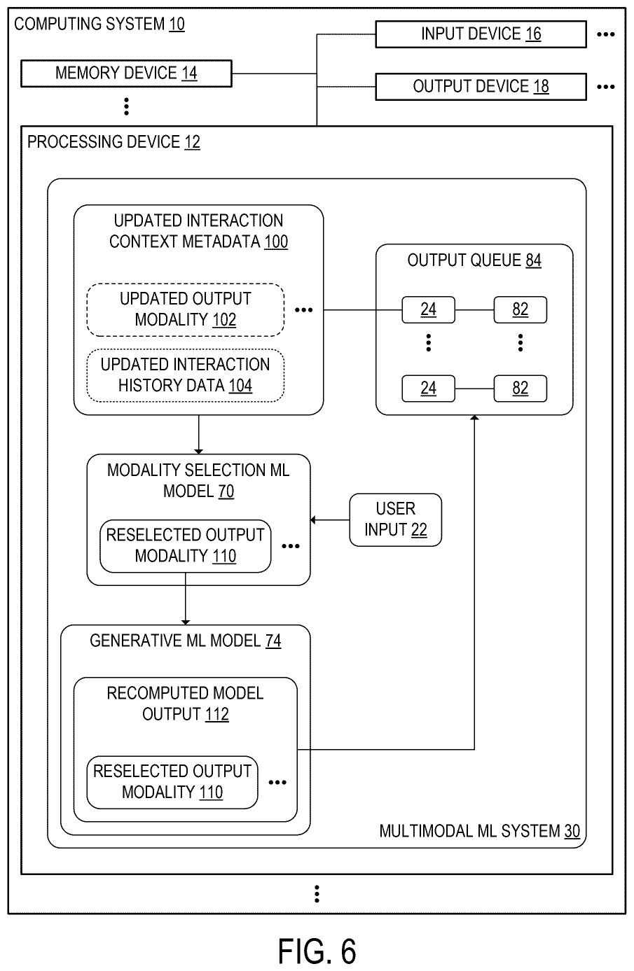

FIG. 6 schematically shows the computing system 10 in an example in which a model output 24 is updated to reflect a change in the interaction context metadata 50. In this example, while the model output 24 is stored in the output queue 84, the one or more processing devices 12 are further configured to receive updated interaction context metadata 100. The updated interaction context metadata 100 may include one or more updated output modalities 102 and/or updated interaction history data 104. For example, while the model output 24 is stored in the output queue 84, the user may connect one or more output devices 18 to, or disconnect one or more output devices 18 from, the computing system 10, thereby changing the set of available output modalities 54. As another example, the user may continue interacting with the multimodal ML system 30 in one or more conversational turns 26 while the model output 24 is stored in the output queue 84, thereby adding to the user's interaction history with the multimodal ML system 30.

At the modality selection ML model 70, in response to receiving the updated interaction context metadata 100, the one or more processing devices 12 are further configured to reselect the one or more selected output modalities 72 associated with the model output 24. To compute one or more reselected output modalities 110, the one or more processing devices 12 are configured to execute the modality selection ML model 70 with the user input 22 and the updated interaction context metadata 100 as inputs. The one or more processing devices 12 are accordingly configured to modify at least one of the one or more selected output modalities 72. One or more other selected output modalities 72 may be left unchanged in some examples.

At the one or more generative ML models 74, the one or more processing devices 12 are further configured to recompute the model output 24 with the one or more reselected output modalities 110. Subsequently to computing the recomputed model output 112, the one or more processing devices 12 may be further configured to add the recomputed model output 112 to the output queue 84. Accordingly, the one or more processing devices 12 are configured to update a stored model output 24 to reflect changes in the interaction context.

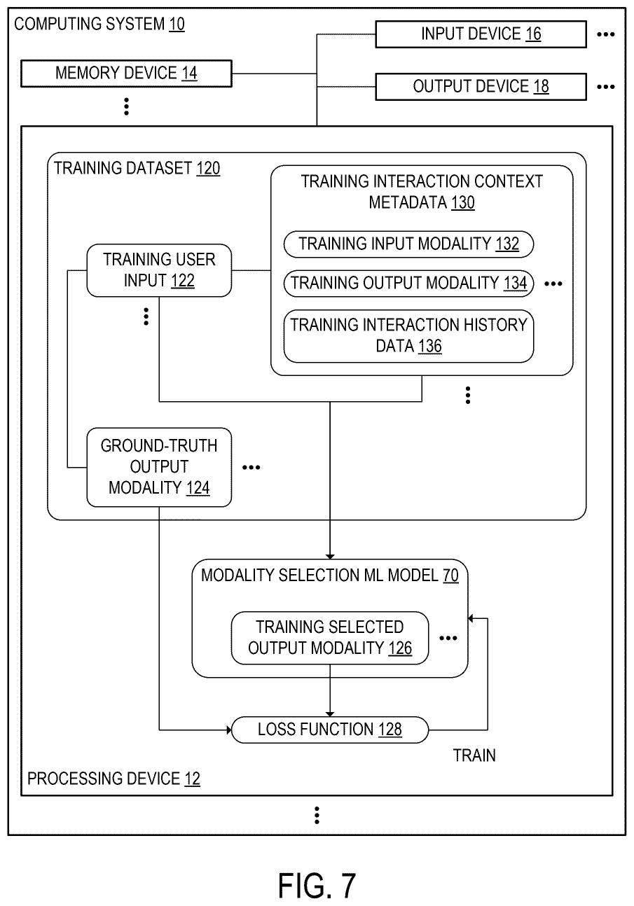

FIG. 7 schematically shows the computing system 10 during training of the modality selection ML model 70. In the example of FIG. 7, the one or more processing devices 12 are configured to receive a training dataset 120. The training dataset 120 may include historical data collected from user interactions with the multimodal ML system 30 in examples in which the users explicitly selected output modalities of the model outputs. In the example of FIG. 7, the training dataset 120 includes a plurality of training user inputs 122 along with respective ground-truth output modalities 124 selected by users of the multimodal ML system 30. In addition, the training dataset 120 includes respective sets of training interaction context metadata 130 associated with the training user inputs 122. The training interaction context metadata 130 may include respective training input modalities 132 in which the training user inputs 122 are received. The training interaction context metadata 130 may further include one or more training output modalities 134 that were available at the multimodal ML model 30 when the multimodal ML model 30 received each of the training user inputs 122. In addition, the training interaction context metadata 130 may further include respective training interaction history data 136 associated with the users who entered the training user inputs 122.

During the training of the modality selection ML model 70, the one or more processing devices 12 are configured to compute respective sets of one or more training selected output modalities 126 at the modality selection ML model 70 using the training user inputs 122 and respective sets of training interaction context metadata 130 as inputs. The one or more processing devices 12 are further configured to input the training selected output modalities 126 and the ground-truth output modalities 124 into a loss function 128 that compares the training selected output modalities 126 to the ground-truth output modalities 124. The one or more processing devices 12 are further configured to perform gradient descent on the value of the loss function 128 with respect to the parameters of the modality selection ML model 70 in order to update those parameters. Accordingly, the one or more processing devices 12 are configured to train the modality selection ML model 70 to predict the one or more output modalities 54 that a user would select.

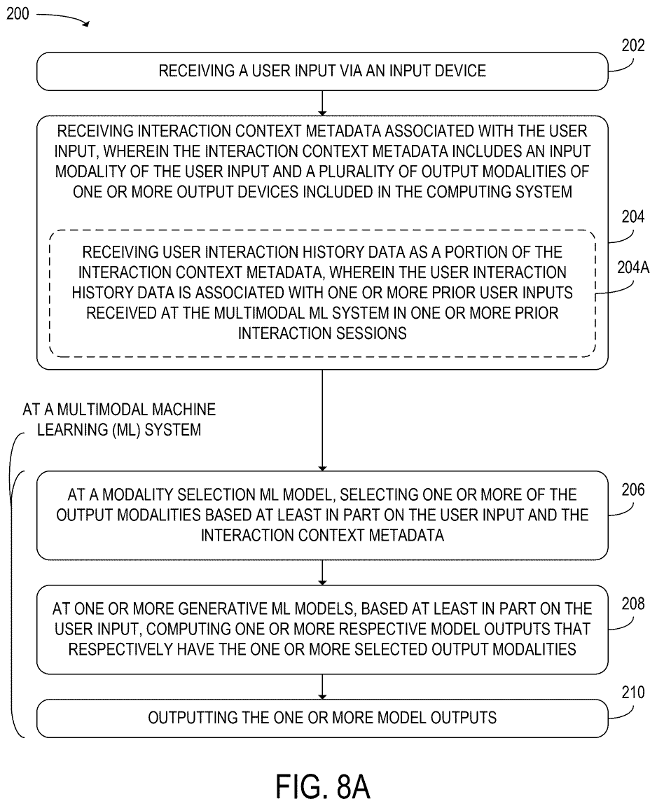

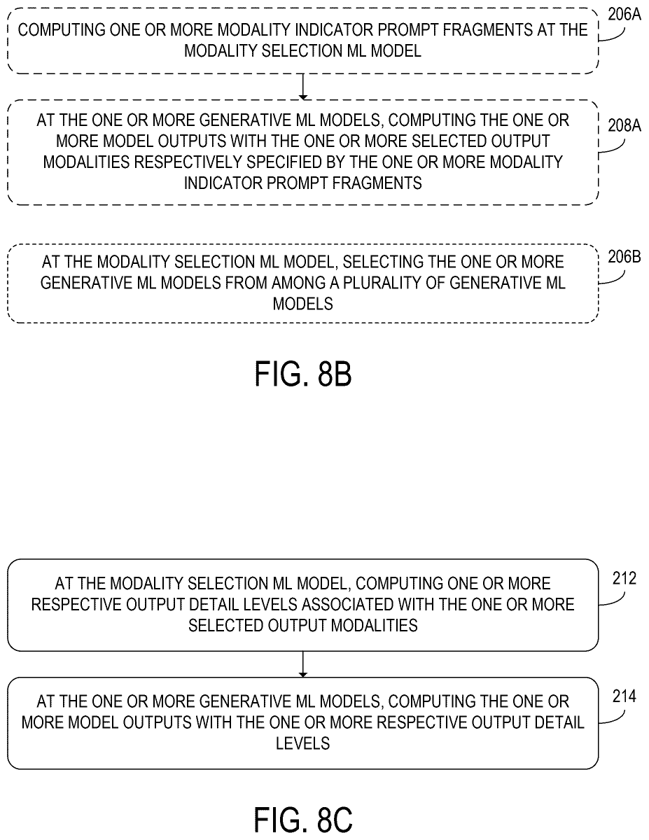

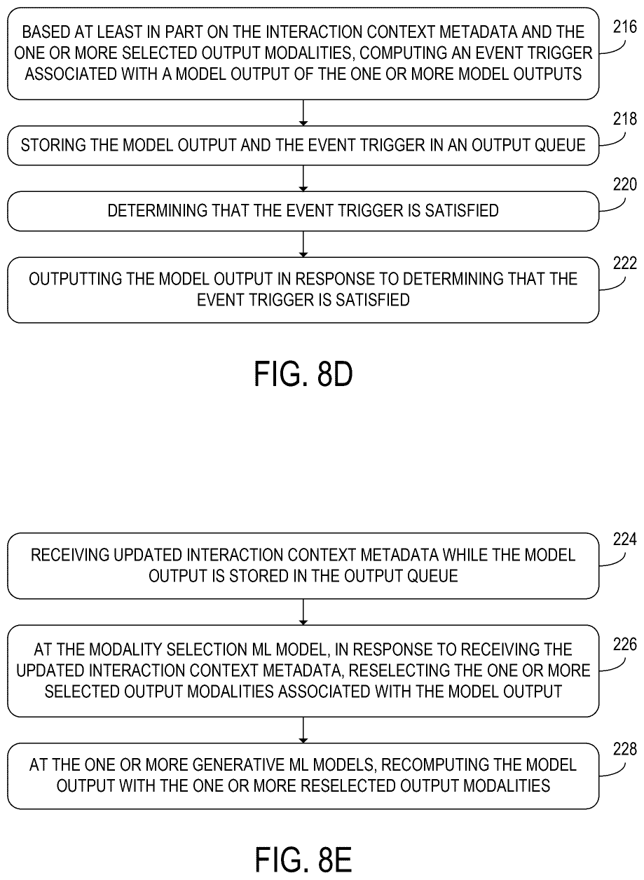

FIG. 8A shows a flowchart of a method 200 for use with a computing system to perform output modality selection at a multimodal ML system. At step 202, the method 200 includes receiving a user input via an input device. The user input may be an input to the multimodal ML system that is entered at a user interface as a conversational turn. At step 204, the method 200 further includes receiving interaction context metadata associated with the user input. The interaction context metadata includes an input modality of the user input. In addition, the interaction context metadata further includes a plurality of output modalities of one or more output devices included in the computing system. In some examples, at step 204A, step 204 may further include receiving user interaction history data associated with one or more prior user inputs. These prior user inputs may have been received at the multimodal ML system in one or more prior interaction sessions.

Steps 206, 208, and 210 are performed at the multimodal ML system. At step 206, the method 200 further includes selecting one or more of the output modalities at a modality selection ML model. The one or more output modalities are selected based at least in part on the user input and the interaction context metadata. Thus, the multimodal ML system dynamically selects the output modalities with which outputs are generated based at least in part on the properties of the user input and the context in which the user input is received. In some examples, the modality selection ML model is included in a central router of the multimodal ML system. The central router may be configured to exchange inputs and outputs of ML models with the user interface and with one or more servers at which those ML models are executed.

At step 208, the method 200 may further include computing one or more respective model outputs at one or more generative ML models based at least in part on the user input. The one or more model outputs respectively have the one or more selected output modalities identified at the modality selection ML model. At step 210, the method 200 further includes outputting the one or more model outputs. The one or more model outputs may be transmitted to at least one output device of the one or more output devices included in the computing system. The at least one output device is configured to output the one or more selected output modalities. In some examples, multiple model outputs computed at the one or more generative ML models may be output to different output devices. Additionally or alternatively, the one or more model outputs may include application program control instructions that are transmitted to an API of another application program.

FIGS. 8B-8E show additional steps of the method 200 that may be performed in some examples. FIG. 8B shows example steps that may be performed at the modality selection ML model. In some examples, at step 206A, selecting the one or more output modalities at step 206 may include computing one or more modality indicator prompt fragments at the modality selection ML model. The modality indicator prompt fragments may be retrieved from a prompt fragment library. In examples in which step 206A is performed, computing the one or more model outputs at step 208 may include, at step 208A, computing the one or more model outputs at the one or more generative ML models with the one or more selected output modalities respectively specified by the one or more modality indicator prompt fragments. The one or more modality indicator prompt fragments may be inserted into the respective context windows of the one or more generative ML models.

Additionally or alternatively to step 206A, selecting the one or more output modalities may include, at step 206B, selecting the one or more generative ML models from among a plurality of generative ML models at the modality selection ML model. Thus, the modality selection ML model may be configured to select one or more generative ML models that have the one or more selected output modalities.

FIG. 8C shows additional steps of the method 200 that may be performed in some examples. At step 212, the method 200 further includes, at the modality selection ML model, computing one or more respective output detail levels associated with the one or more selected output modalities. At step 214, the method 200 further includes, at the one or more generative ML models, computing the one or more model outputs with the one or more respective output detail levels. For example, the output detail level may be a target length of the model output. As another example, a model output with a lower level of detail may be computed by summarizing a model output that has a higher level of detail. The low-detail and high-detail model outputs may be presented using different output modalities.

FIG. 8D shows additional steps of the method 200 that may be performed in some examples to perform output scheduling for the one or more model outputs. At step 216, based at least in part on the interaction context metadata and the one or more selected output modalities, the method 200 further includes computing an event trigger associated with a model output of the one or more model outputs. In some examples, the event trigger may be computed at an output scheduling ML model. In such examples, the output scheduling ML model may receive the interaction context metadata and the one or more selected output modalities as inferencing inputs.

At step 218, the method further includes storing the model output and the event trigger in an output queue. In some examples, the computing system may include a plurality of output devices, and the output queue may be included among a plurality of device-specific output queues respectively associated with the output devices. As another example, the output queue may be included among a plurality of modality-specific output queues respectively associated with the plurality of output modalities.

At step 220, the method 200 further includes determining that the event trigger is satisfied. For example, the event trigger may be satisfied when an output device or output modality that was previously in use to present another output becomes available. As another example, the event trigger may be a predetermined duration elapsing. At step 222, in response to determining that the event trigger is satisfied, the method 200 further includes outputting the model output.

FIG. 8E shows additional steps of the method 200 that may be performed in some examples in which the steps of FIG. 8D are performed. At step 224, the method 200 further includes receiving updated interaction context metadata while the model output is stored in the output queue. For example, the updated interaction context metadata may include one or more updated output modalities that are available to the multimodal ML system. Additionally or alternatively, the updated interaction context metadata may include updated interaction history data associated with the user.

At step 226, in response to receiving the updated interaction context metadata, the method 200 further includes reselecting the one or more selected output modalities associated with the model output at the modality selection ML model. The one or more reselected output modalities may be computed at the modality selection ML model with the user input and the updated interaction context metadata as inferencing inputs. At step 228, the method 200 further includes recomputing the model output with the one or more reselected output modalities at the one or more generative ML models. The output modalities of at least a portion of the one or more model outputs may accordingly be updated when the interaction context changes.

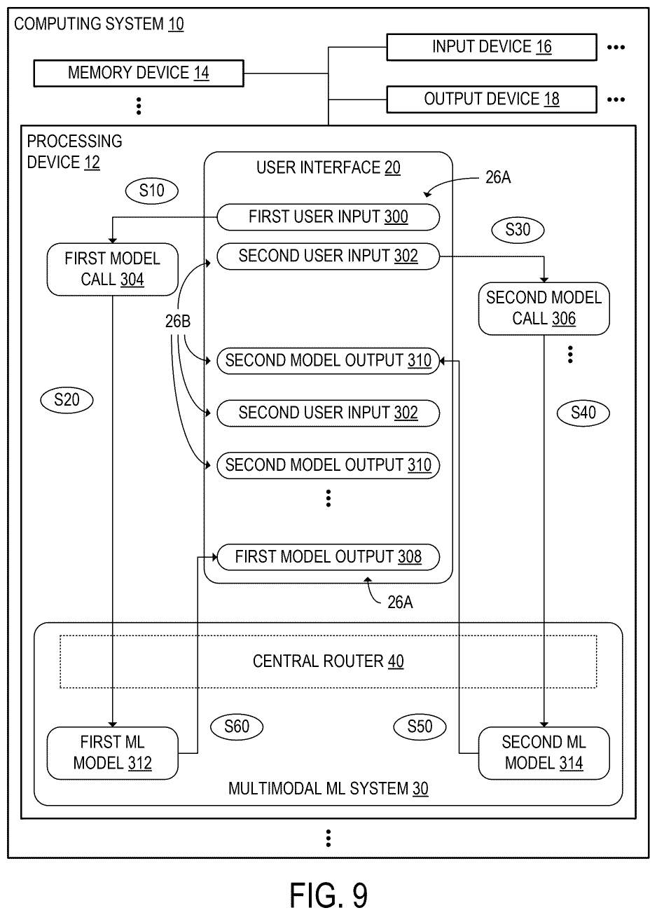

FIG. 9 schematically shows the computing system 10 when a plurality of asynchronous sets of conversational turns 26 are exchanged with the user over the user interface 20. These sets of conversational turns 26 include a set of first conversational turns 26A and a set of second conversational turns 26B. The first conversational turns 26A are exchanged between the user interface 20 and a first ML model 312, whereas the second conversational turns 26B are exchanged between the user interface 20 and a second ML model 314. The set of first conversational turns 26A includes a first user input 300 and a first model output 308. The set of second conversational turns 26B includes one or more second user inputs 302 and one or more second model outputs 310.

At step S10, as shown in the example of FIG. 9, the one or more processing devices 12 are configured to receive the first user input 300 at the user interface 20. At step S20, in response to receiving the first user input 300, the one or more processing devices 12 are further configured to initiate a first model call 304 to a first ML model 312 included in the multimodal ML system 30. The first model call 304 is an instruction to perform one or more inferencing passes at the first ML model.

During execution of the first model call 304, at step S30, the one or more processing devices 12 are further configured to receive the one or more second user inputs 302. At step S40, the one or more processing devices 12 are further configured to perform one or more second model calls 306 to a second ML model 314 included in the multimodal ML system 30. At the second ML model 314, the one or more processing devices 12 are further configured to compute the one or more second model outputs 310 based at least in part on the one or more second user inputs 302. The one or more processing devices 12 are further configured to output the one or more second model outputs 310 to the user interface 20 at step S50.

Subsequently to outputting the one or more second model outputs 310, the one or more processing devices 12 are further configured to receive the first model output 308 computed at the first ML model 312 in response to receiving the first user input 300. At step S60, the one or more processing devices 12 are further configured to output the first model output 308 to the user interface 20. Thus, while the user waits for the first ML model 312 to process the first user input 300, the multimodal ML system 30 is further configured to exchange the second set of second conversational turns 26B with the user over the user interface 20. This asynchronous structure of the set of first conversational turns 26A and the set of second conversational turns 26B, with the one or more second user inputs 302 and the one or more second model outputs 310 nested between the first user input 300 and the first model output 308, allows the multimodal ML system 30 to continue processing user inputs while the first model call 304 is executed.

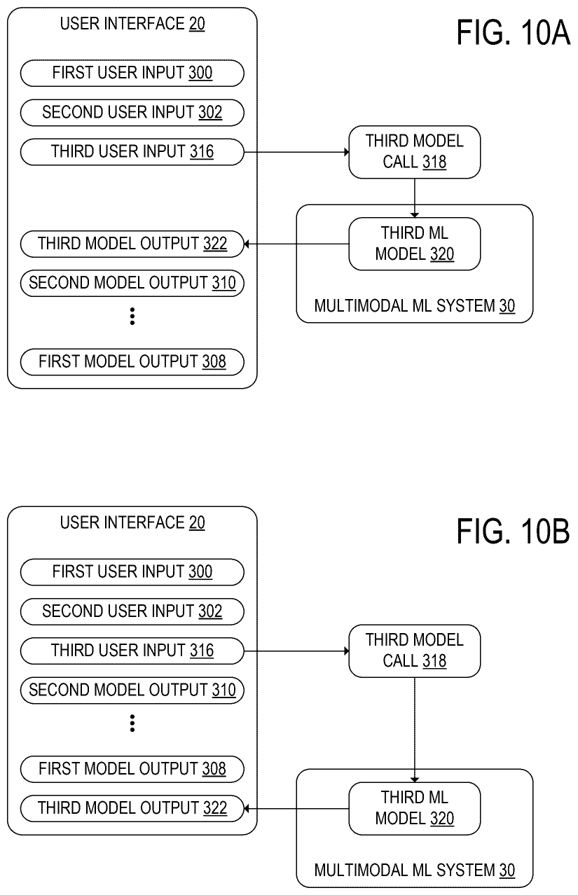

In the example of FIG. 9, the nested structure of the second conversational turns 26B between the first conversational turns 26A has two layers. In other examples, one or more additional sets of conversational turns 26 may be nested within the set of first conversational turns 26A and/or the set of second conversational turns 26B. FIG. 10A schematically shows the user interface 20 and the multimodal ML system 30 in an example in which the one or more processing devices 12 are configured to receive a third user input 316 subsequently to the second user input 302. The one or more processing devices 12 are further configured to initiate a third model call 318 to a third ML model 320 included in the multimodal ML system 30. These additional sets of conversational turns 26 may utilize one or more additional ML models 32 included in the multimodal ML system 30. At the third ML model 320, the one or more processing devices 12 are configured to compute a third model output 322. In the example of FIG. 10A, the third model output 322 is output to the user interface 20 prior to the second model output 310. Thus, the conversational turns 26 have three layers of nesting in the example of FIG. 10A.

In some examples, rather than following a strictly nested structure, the user inputs 22 and model outputs 24 of the different sets of conversational turns 26 may be at least partially interleaved. In the example of FIG. 10B, the one or more processing devices 12 are configured to receive the third user input 316 between the second user input 302 and the second model output 310. However, in contrast to FIG. 10B, the one or more processing devices 12 are configured to output the third model output 322 to the user interface after the first model output 308.

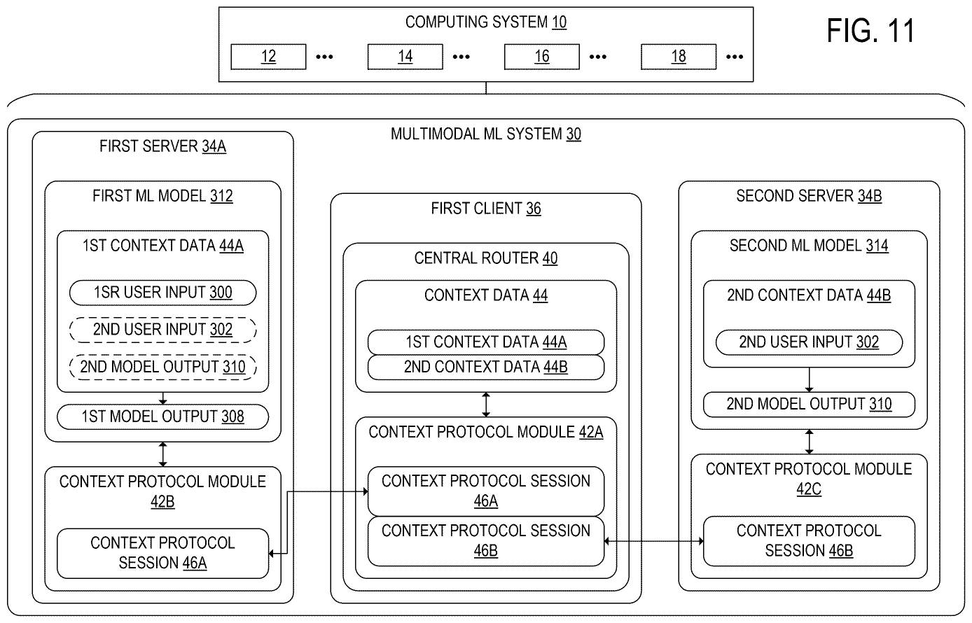

As discussed above with reference to FIG. 1, the multimodal ML system 30 may utilize a server-client configuration. FIG. 11 schematically shows the computing system 10 in an example in which the first ML model 312 is executed at a first server 34A and the second ML model 314 is executed at a second server 34B. In addition, the multimodal ML system 30 includes a central router 40 executed at a first client 36. The central router 40 is configured to transmit context data 44 between the first ML model 312 and the second ML model 314 using a context protocol. The context data 44, in the example of FIG. 11, includes first context data 44A that is included in a context window of the first ML model 312 during computation of the first model output 308. The context data 44 further includes second context data 44B that is included in a context window of the second ML model 314 during computation of the second model output 310.

In the example of FIG. 11, the one or more processing devices 12 are configured to execute context protocol modules 42A, 42B, and 42C at the first client 36, the first server 34A, and the second server 34B, respectively. The first client 36 is configured to communicate with the first server 34A in a context protocol session 46A instantiated between the context protocol modules 42A and 42B. Similarly, the first client 36 is configured to communicate with the second server 34B in a context protocol session 46B instantiated between the context protocol modules 42A and 42C. The first client 36 may conduct the context protocol sessions 46A and 46B concurrently. Communication between the first client 36 and the user interface 20 (which may be executed at a second client 38, as shown in the example of FIG. 1) may also occur while the context protocol sessions 46A and 46B are open.

In some examples, at the central router 40, the one or more processing devices 12 may be further configured to transmit the second user input 302 and/or the second model output 310 to the first server 34A over the context protocol prior to receiving the first model output 308. In such examples, the first ML model 312 may be further configured to compute the first model output 308 based at least in part on the second model output 310. The second user input 302 and/or the second model output 310 may be used as an inferencing input at the first ML model 312 in examples in which the first model call 304 includes instructions to perform a plurality of inferencing passes through the first ML model 312. In such examples, the second user input 302 and/or the second model output 310 may be included in the first context data 44A for one or more of the inferencing passes that occur after the second user input 302 and/or the second model output 310 has been received at the central router 40 and transmitted to the first server 34A. Thus, results of the second model call 306 may be incorporated into the computation of the first model output 308.

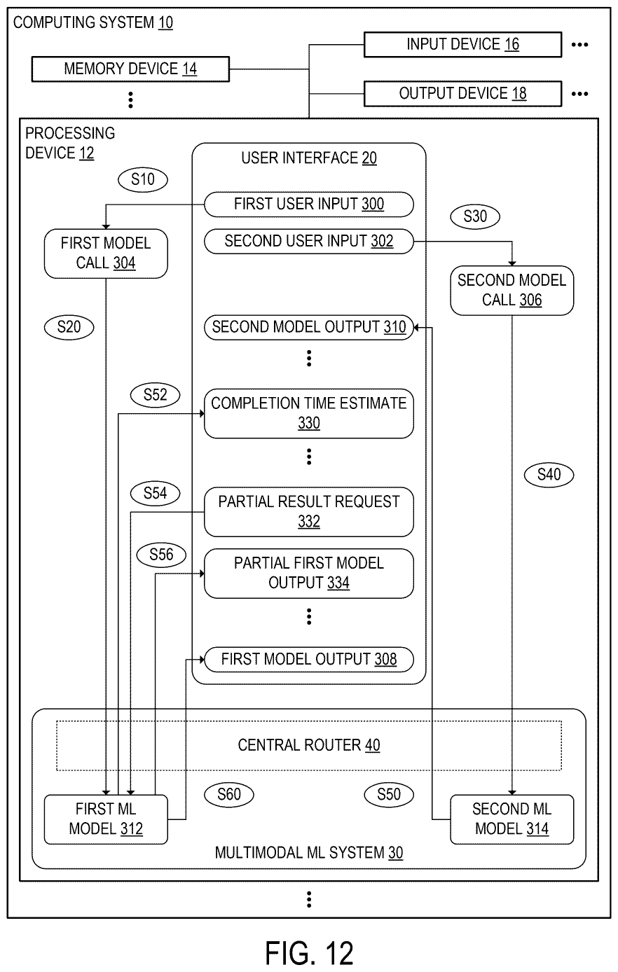

FIG. 12 schematically shows the computing system 10 in an example in which one or more intermediate results of the first model call 304 are transmitted to the user interface 20 prior to transmitting the first model output 308. In some examples, at the central router 40, the one or more processing devices 12 are further configured to receive a completion time estimate 330 from the first server 34A. The completion time estimate 330 is an estimate of a remaining amount of time before the first server 34A outputs the first model output 308. Thus, the user may be notified of the amount of time remaining before the first model call 304 is completed. The completion time estimate 330, as shown in the example of FIG. 12, is received at step S52, which occurs subsequently to initiating the first model call 304. Although, in the example of FIG. 12, the completion time estimate 330 is received subsequently to exchanging a second user input 302 and a second model output 310 over the user interface 20, the completion time estimate 330 may be received prior to initiating the second model call 306 in other examples. In some examples, the one or more processing devices 12 may be configured to transmit completion time estimates 330 to the user interface 20 at a predetermined time interval. Additionally or alternatively to the completion time estimate 330, a completion proportion estimate (e.g., a completion percentage) may be received from the first server 34A and output to the user interface 20 in some examples.

In the example of FIG. 12, at step S54, the one or more processing devices 12 are further configured to transmit a partial result request 332 to the first server 34A prior to receiving the first model output 308. The partial result request 332 is a request to output a partial result of the first model call 304. In some examples, as shown in FIG. 12, the user may enter the partial result request 332 at the user interface 20. Alternatively, the multimodal ML system 30 may programmatically generate a partial result request 332 and transmit the partial result request 332 to the first server 34A.

In response to transmitting the partial result request to the first server 34A, the one or more processing devices 12 are further configured to receive a partial first model output 334 at the central router 40. At step S56, the one or more processing devices 12 are further configured to output the partial first model output 334 to the user interface 20 prior to outputting the first model output 308. The partial first model output 334 may, for example, be a partially completed text, image, or audio output. In examples in which the first ML model 312 is a reasoning model, the partial first model output 334 may include text written to a scratchpad of the first ML model 312. As another example, when the first ML model 312 is a denoising diffusion model configured to generate an image output, the partial first model output 334 may be an image computed at an intermediate denoising iteration.

In examples in which a partial first model output 334 is transmitted to the user interface 20, the user may interact with the multimodal ML system 30 in a manner that is informed by the computation performed at the first ML model 312 even before the first model output 308 is completed. For example, if the partial first model output 334 does not meet the user's intentions for the characteristics of the first model output 308, the user may instruct the first ML model 312 to stop or restart the computation of the first model output 308. As another example, the user may utilize information included in the partial first model output 334 when providing instructions to the second ML model 314. In some examples, the partial first model output 334 may also be included in the second context data 44B that the second ML model 314 uses as an input. Thus, the one or more processing devices 12 may be further configured to compute at least a portion of the one or more second model outputs 310 based at least in part on the partial first model output 334.

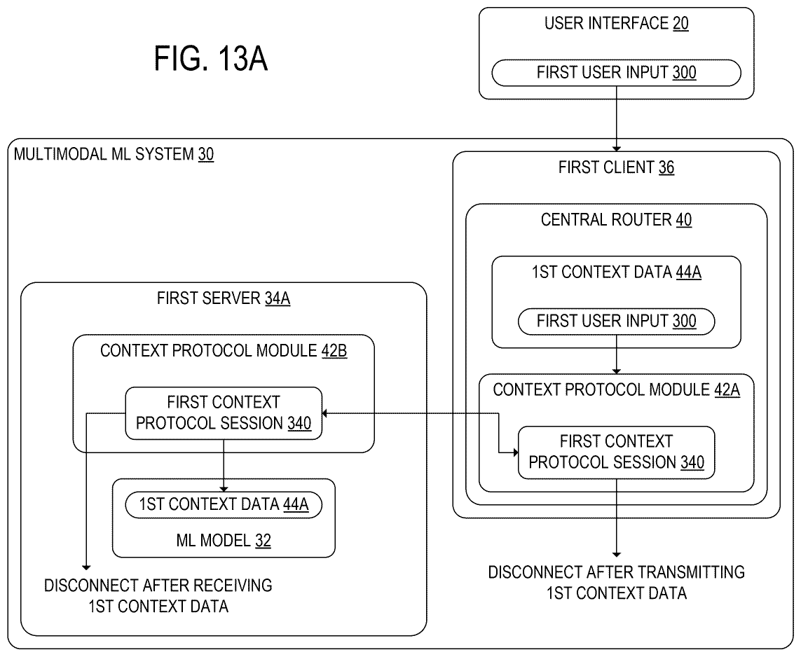

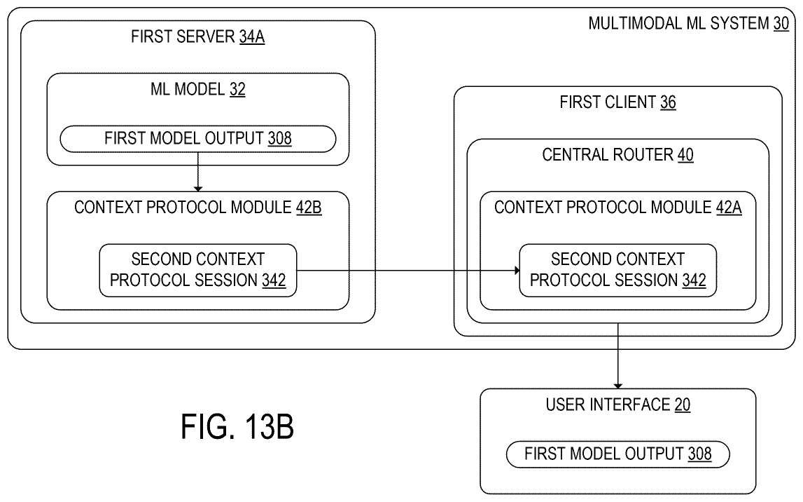

FIGS. 13A-13B show the context protocol sessions 46 executed at the central router 40 in additional detail. As shown in FIG. 13A, the one or more processing devices 12 are configured to transmit the first user input 300 to the first server 34A over the context protocol in a first context protocol session 340 between the central router 40 and the first server 34A. The first context protocol session 340 is a session in which context data 44 is communicated between the context protocol module 42A of the first client 36 and the context protocol module 42B of the first server 34A.

The one or more processing devices 12 are further configured to disconnect the first context protocol session 340 in response to transmitting the first user input 300 to the first server 34A. Thus, the first context protocol session 340 is disconnected after the central router 40 transmits the first context data 44A and the first server 34A receives the first context data 44A. In some examples, the central router 40 may disconnect the first context protocol session 340 in response to receiving a confirmation from the first server 34A that the first server 34A has received the first context data 44A.

As shown in FIG. 13B, the one or more processing devices 12 are further configured to establish a second context protocol session 342 between the central router 40 and the first server 34A subsequently to disconnecting the first context protocol session 340. At the central router 40, the one or more processing devices 12 are further configured to receive the first model output 308 from the first server 34A during the second context protocol session 342. Thus, rather than keeping a connection to the first server 34A open for the entire wait time in which the first model output 308 is computed, the central router 40 may disconnect from the first server 34A after transmitting the first context data 44A and reconnect to the first server 34A to receive the first model output 308. The one or more processing devices 12 may therefore reduce the amount of bandwidth used to communicate between the first server 34A and the first client 36. However, the central router 40 may remain connected to the user interface 20 when the central router 40 is disconnected from the first server 34A. The central router 40 may accordingly communicate with the user interface 20 to exchange the second conversational turns 26B while waiting to receive the first model output 308.

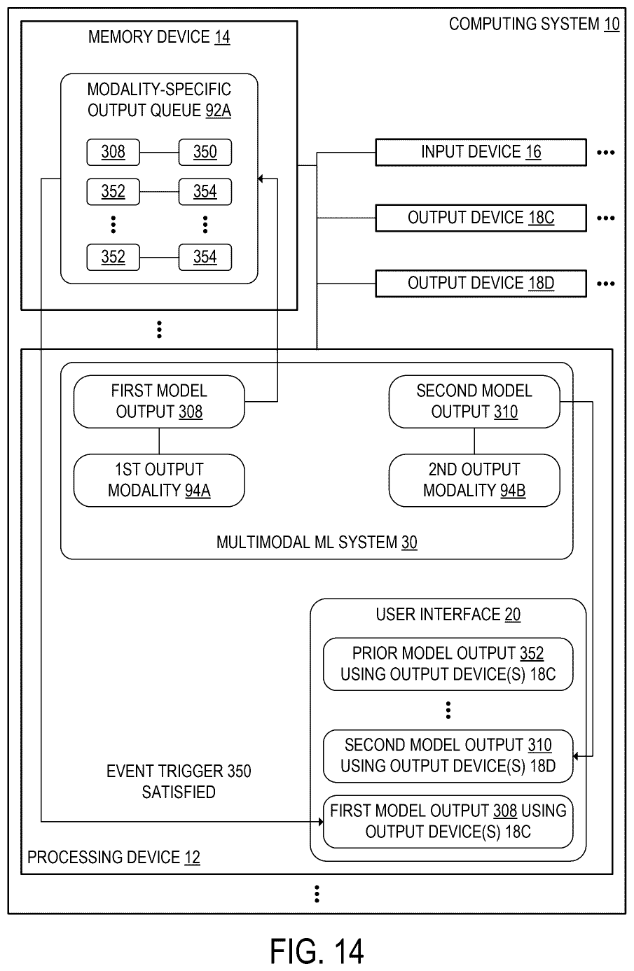

FIG. 14 schematically shows the computing system 10 in an example in which the one or more memory devices 14 store a modality-specific output queue 92A associated with a first output modality 94A, as discussed above with reference to FIG. 5B. In the example of FIG. 14, the one or more memory devices 14 store a plurality of model outputs 24C with corresponding event triggers 82C in the modality-specific output queue 92A. The one or more memory devices 14 that store the modality-specific output queue 92A may be memory devices of the first client 36. The computing system 10, in the example of FIG. 14, further includes one or more output devices 18C that are configured to output the first output modality 94A. In addition, the computing system 10 includes one or more output devices 18D that are configured to output a second output modality 94B that differs from the first output modality 94A. The output devices 18C and 18D may be included in the second client 38.

In the example of FIG. 14, the one or more processing devices 12 are further configured to determine that the first model output 308 has the first output modality 94A. In addition, the one or more processing devices 12 are further configured to determine that the output queue 92A includes at least one prior model output 352. Thus, the multimodal ML system 30 already stores at least one prior model output 352 that has the same output modality as the first model output 308 and that has not yet been presented to the user interface 20 or input into another application program 64. The one or more prior model outputs 352 may have one or more respective event triggers 354.

In response to determining that the first model output 308 has the first output modality 94A and that the output queue 92A includes the at least one prior model output 352, the one or more processing devices 12 are further configured to store the first model output 308 in the output queue 92A. An event trigger 350 associated with the first model output 308 may also be stored in the output queue 92A.

The one or more processing devices 12 are further configured to transmit the at least one prior model output 352 to one or more output devices 18C configured to output the first output modality 94A. Each of the at least one prior model output 352 may be transmitted to the one or more output devices 18C in response to the event trigger 354 associated with that prior model output 352 being satisfied. Subsequently to transmitting the at least one prior model output 352, the one or more processing devices 12 are further configured to transmit the first model output 308 to the one or more output devices 18C. The first model output 308 may be transmitted in response to the event trigger 350 being satisfied.

The one or more processing devices may be configured to output the one or more second model outputs 310 to the user interface in the second output modality 94B. The one or more second model outputs 310 may be output before, after, or interspersed with the one or more prior model outputs 352 that utilize the first output modality 94A. Thus, the one or more processing devices 12 may be configured to output the one or more second model outputs 310 to the user interface 20 while waiting for the one or more output devices 18C to become available for presenting the first model output 308 to the user.

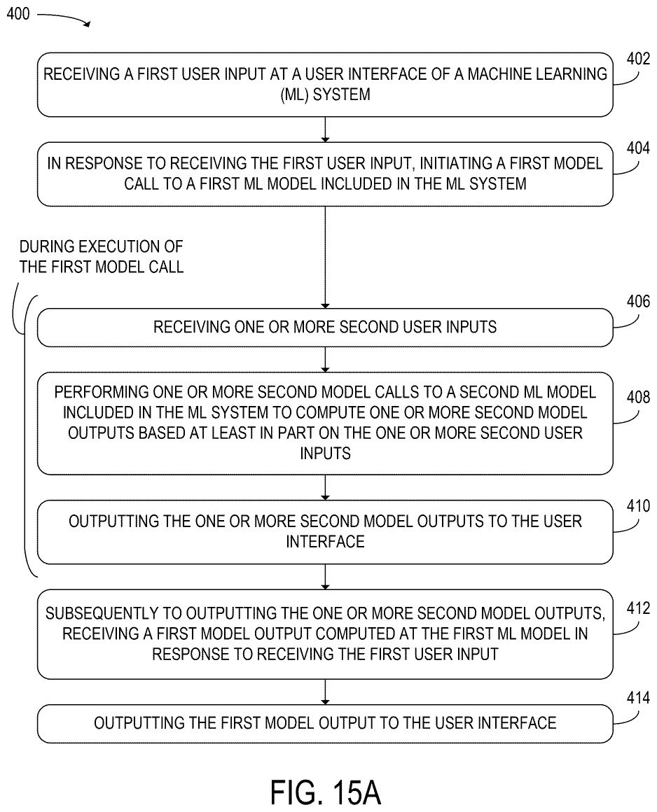

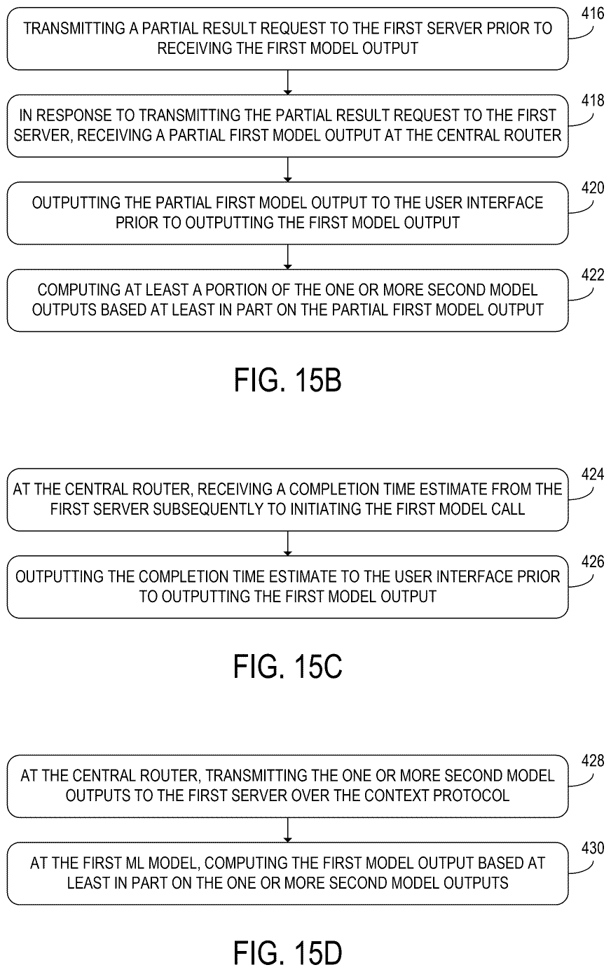

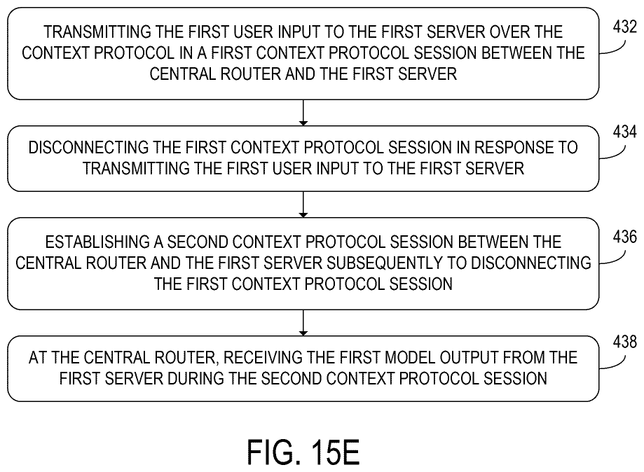

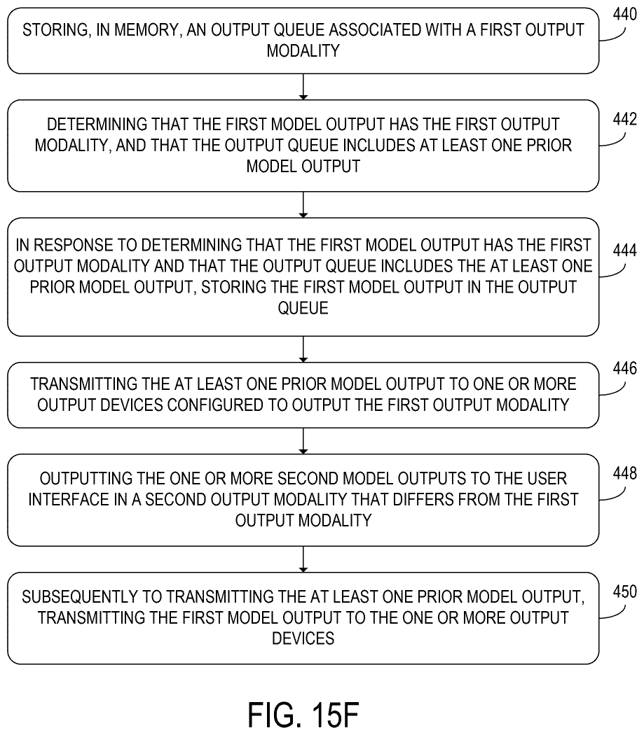

FIG. 15A shows a flowchart of an example method 400 for use with a computing system exchange a plurality of asynchronous sets of conversational turns with a respective plurality ML models. At step 402, the method 400 includes receiving a first user input at a user interface of an ML system. The ML system includes a plurality of ML models. For example, the ML system may be a multimodal ML system that includes ML models with different output modalities.

At step 404, in response to receiving the first user input, the method 400 further includes initiating a first model call to a first ML model included in the ML system. The first model call may include instructions to perform one or more inferencing passes at the first ML model. In some examples, the first ML model is executed at a first server. In such examples, the ML system may further include a central router configured to transmit context data between the plurality of ML models using a context protocol. For example, the central router may be implemented at a first client. The user interface, in such examples, may be implemented at the first client or at a second client configured to communicate with the first client.

Steps 406, 408, and 410 are performed during execution of the first model call. At step 406, the method 400 further includes receiving one or more second user inputs at the user interface. At step 408, the method 400 further includes performing one or more second model calls to a second ML model included in the ML system to compute one or more second model outputs based at least in part on the one or more second user inputs. The second ML model may be executed at a second server that is configured to communicate with the central router using the context protocol. At step 410, the method 400 further includes outputting the one or more second model outputs to the user interface.

At step 412, subsequently to outputting the one or more second model outputs, the method 400 further includes receiving a first model output computed at the first ML model in response to receiving the first user input. The first model output may be received at the central router over the context protocol. At step 414, the method 400 further includes outputting the first model output to the user interface. Thus, the first user input and the one or more second user inputs are processed and output asynchronously, thereby presenting the first and second model outputs in a manner that reduces backlogs at the user interface.

FIGS. 15B-15F show additional steps of the method 400 that are performed in some examples. At step 416, as shown in the example of FIG. 15B, the method 400 may further include transmitting a partial result request to the first server prior to receiving the first model output. At step 418, the method 400 may further include receiving a partial first model output at the central router in response to transmitting the partial result request to the first server. At step 420, the method 400 may further include outputting the partial first model output to the user interface prior to outputting the first model output. Thus, the user may be informed of partial results of the first model call prior to its completion.

At step 422, the method 400 may further include computing at least a portion of the one or more second model outputs based at least in part on the partial first model output. The partial first model output may accordingly be transmitted to the second ML model over the context protocol and may be included in the context of the second ML model.

At step 424, as shown in the example of FIG. 15C, the method 400 may further include receiving a completion time estimate from the first server at the central router subsequently to initiating the first model call. At step 426, the method 400 may further include outputting the completion time estimate to the user interface prior to outputting the first model output. In some examples, a completion proportion estimate may be received at the central router and output to the user interface additionally or alternatively to the completion time estimate.

At step 428, as shown in the example of FIG. 15D, the method 400 may further include, at the central router, transmitting the one or more second model outputs to the first server over the context protocol. At step 430, the method 400 may further include, at the first ML model, computing the first model output based at least in part on the one or more second model outputs. In some examples, the one or more second user inputs may also be transmitted to the first server and used to compute the first model output.

At step 432, as shown in the example of FIG. 15E, the method 400 may further include transmitting the first user input to the first server over the context protocol in a first context protocol session between the central router and the first server. At step 434, the method 400 may further include disconnecting the first context protocol session in response to transmitting the first user input to the first server. The central router may remain connected to the user interface when the central router is disconnected from the first server.

At step 436, the method 400 may further include establishing a second context protocol session between the central router and the first server subsequently to disconnecting the first context protocol session. The first server may establish the second context protocol session in response to completing the computation of the first model output. At step 438, the method 400 may further include receiving the first model output from the first server at the central router during the second context protocol session.

At step 440, as shown in the example of FIG. 15F, the method 400 may further include storing, in memory, an output queue associated with a first output modality. The memory may be associated with the central router and may be instantiated in one or more memory devices that are included in the first client. At step 442, the method 400 may further include determining that the first model output has the first output modality, and that the output queue includes at least one prior model output. At step 444, in response to determining that the first model output has the first output modality and that the output queue includes the at least one prior model output, the method 400 may further include storing the first model output in the output queue. An event trigger associated with the first model output may also be stored in the output queue.

At step 446, the method 400 may further include transmitting the at least one prior model output to one or more output devices configured to output the first output modality. The at least one prior model output may accordingly be cleared from the output queue. In some examples, at step 448, the method 400 may further include outputting the one or more second model outputs to the user interface in a second output modality that differs from the first output modality. In some examples, steps 446 and 448 may be performed at least partially in parallel. The at least one prior model output and the one or more second model outputs may be presented at the user interface using different output devices. At step 450, the method 400 may further include transmitting the first model output to the one or more output devices subsequently to transmitting the at least one prior model output. Accordingly, the multimodal ML system may wait to present the first model output to the user interface until the one or more output devices configured to output the corresponding output modality are available. The one or more second model outputs may be presented using a different output modality while the multimodal ML system waits to present the first model output.

Using the systems and methods discussed above, a multimodal ML system dynamically selects the output modalities in which ML model outputs are generated. These output modalities are computed in a context-specific manner that accounts for the available capabilities of the input and output devices included in the computing system. Users' interaction histories with the ML system may also be incorporated into the determination of the one or more output modalities of a model output.

The systems and methods discussed above also allow for more varied patterns of user interaction with ML systems, compared to conventional ML system interfaces in which one model output is generated for each user input. The above systems and methods allow user inputs and model outputs to be processed in multiple asynchronous streams that are coordinated at a central router. In scenarios in which different models take significantly different amounts of time to generate their outputs, the asynchronous communication patterns discussed above may prevent lengthy model calls from becoming a bottleneck to user interaction with the ML system. Output queues and event triggers may also be used to provide further control over the times at which model outputs are presented to the user interface. For example, output queues may be used to schedule utilization of different output devices and/or output modalities by outputs of the ML system.

The methods and processes described herein are tied to a computing system of one or more computing devices. In particular, such methods and processes can be implemented as a computer-application program or service, an application-programming interface (API), a library, and/or other computer-program product.

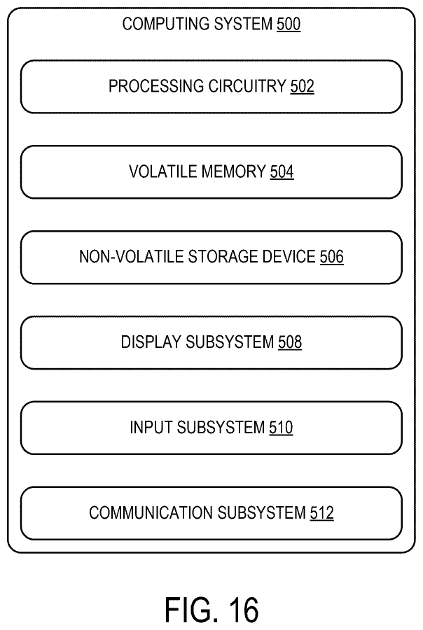

FIG. 16 schematically shows a non-limiting embodiment of a computing system 500 that can enact one or more of the methods and processes described above. Computing system 500 is shown in simplified form. Computing system 500 may instantiate the computing system discussed above with reference to FIG. 1. Components of computing system 500 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 500 includes processing circuitry 502, volatile memory 504, and a non-volatile storage device 506. Computing system 500 may optionally include a display subsystem 508, input subsystem 510, communication subsystem 512, and/or other components not shown in FIG. 16.

Processing circuitry 502 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 502 may be single-core or multi-core, and the instructions executed thereon may be configured for sequential, parallel, and/or distributed processing. Individual components of the processing circuitry 502 optionally may be distributed among two or more separate devices, which may be remotely located and/or configured for coordinated processing. For example, aspects of the computing system 500 disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 502.

Non-volatile storage device 506 includes one or more physical devices configured to hold instructions executable by the processing circuitry 502 to implement the methods and processes described herein. When such methods and processes are implemented, the state of non-volatile storage device 506 may be transformed—e.g., to hold different data.

Non-volatile storage device 506 may include physical devices that are removable and/or built in. Non-volatile storage device 506 may include optical memory, semiconductor memory, and/or magnetic memory, or other mass storage device technology. Non-volatile storage device 506 may include nonvolatile, dynamic, static, read/write, read-only, sequential-access, location-addressable, file-addressable, and/or content-addressable devices. It will be appreciated that non-volatile storage device 506 is configured to hold instructions even when power is cut to the non-volatile storage device 506.

Volatile memory 504 may include physical devices that include random access memory. Volatile memory 504 is typically utilized by processing circuitry 502 to temporarily store information during processing of software instructions. It will be appreciated that volatile memory 504 typically does not continue to store instructions when power is cut to the volatile memory 504.

Aspects of processing circuitry 502, volatile memory 504, and non-volatile storage device 506 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 500 typically implemented in software by a processor to perform a particular function using portions of volatile memory, which function involves transformative processing that specially configures the processor to perform the function. Thus, a module, program, or engine may be instantiated via processing circuitry 502 executing instructions held by non-volatile storage device 506, using portions of volatile memory 504. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 508 may be used to present a visual representation of data held by non-volatile storage device 506. The visual representation may take the form of a graphical user interface (GUI). As the herein described methods and processes change the data held by the non-volatile storage device 506, and thus transform the state of the non-volatile storage device 506, the state of display subsystem 508 may likewise be transformed to visually represent changes in the underlying data. Display subsystem 508 may include one or more display devices utilizing virtually any type of technology. Such display devices may be combined with processing circuitry 502, volatile memory 504, and/or non-volatile storage device 506 in a shared enclosure, or such display devices may be peripheral display devices.

When included, input subsystem 510 may comprise or interface with one or more user-input devices such as a keyboard, mouse, touch screen, camera, or microphone.

When included, communication subsystem 512 may be configured to communicatively couple various computing devices described herein with each other, and with other devices. Communication subsystem 512 may include wired and/or wireless communication devices compatible with one or more different communication protocols. As non-limiting examples, the communication subsystem 512 may be configured for communication via a wired or wireless local- or wide-area network, broadband cellular network, etc. In some embodiments, the communication subsystem 512 may allow computing system 500 to send and/or receive messages to and/or from other devices via a network such as the Internet.

The following paragraphs discuss several aspects of the present disclosure. According to one aspect of the present disclosure, a computing system is provided, including one or more input devices, one or more output devices, and one or more processing devices. The one or more processing devices are configured to receive a user input via an input device of the one or more input devices. The one or more processing devices are further configured to receive interaction context metadata associated with the user input. The interaction context metadata includes an input modality of the user input and a plurality of output modalities of the one or more output devices. At a multimodal machine learning (ML) system, at a modality selection ML model, the one or more processing devices are further configured to select one or more of the output modalities based at least in part on the user input and the interaction context metadata. At one or more generative ML models, based at least in part on the user input, the one or more processing devices are further configured to compute one or more respective model outputs that respectively have the one or more selected output modalities. The one or more processing devices are further configured to output the one or more model outputs.

According to this aspect, the interaction context metadata may further include user interaction history data associated with one or more prior user inputs received at the multimodal ML system in one or more prior interaction sessions.

According to this aspect, the one or more processing devices may be further configured to, based at least in part on the interaction context metadata and the one or more selected output modalities, compute an event trigger associated with a model output of the one or more model outputs. The one or more processing devices may be further configured to store the model output and the event trigger in an output queue. The one or more processing devices may be further configured to determine that the event trigger is satisfied. The one or more processing devices may be further configured to output the model output in response to determining that the event trigger is satisfied.

According to this aspect, the computing system may include a plurality of output devices. The output queue may be included among a plurality of device-specific output queues respectively associated with the output devices.

According to this aspect, the output queue may be included among a plurality of modality-specific output queues respectively associated with the plurality of output modalities.

According to this aspect, the one or more processing devices may be further configured to receive updated interaction context metadata while the model output is stored in the output queue. At the modality selection ML model, in response to receiving the updated interaction context metadata, the one or more processing devices may be further configured to reselect the one or more selected output modalities associated with the model output. At the one or more generative ML models, the one or more processing devices may be further configured to recompute the model output with the one or more reselected output modalities.

According to this aspect, the one or more processing devices may be configured to compute the event trigger at an output scheduling ML model included in the multimodal ML system.

According to this aspect, the one or more processing devices may be further configured to, at the modality selection ML model, compute one or more respective output detail levels associated with the one or more selected output modalities. At the one or more generative ML models, the one or more processing devices may be further configured to compute the one or more model outputs with the one or more respective output detail levels.

According to this aspect, the output modalities include a displayed text modality, a displayed image modality, an audio modality, and an application program control modality.

According to this aspect, the one or more processing devices may be further configured to, at the modality selection ML model, select two or more of the output modalities from among the plurality of output modalities. The one or more processing devices may be further configured to concurrently generate two or more model outputs at respective instances of the one or more generative ML models.

According to this aspect, the one or more processing devices may be further configured to compute one or more modality indicator prompt fragments at the modality selection ML model. At the one or more generative ML models, the one or more processing devices may be further configured to compute the one or more model outputs with the one or more selected output modalities respectively specified by the one or more modality indicator prompt fragments.

According to this aspect, at the modality selection ML model, the one or more processing devices may be configured to select the one or more generative ML models from among a plurality of generative ML models.

According to another aspect of the present disclosure, a method for use with a computing system is provided. The method includes receiving a user input via an input device. The method further includes receiving interaction context metadata associated with the user input. The interaction context metadata includes an input modality of the user input and a plurality of output modalities of one or more output devices included in the computing system. At a multimodal machine learning (ML) system, at a modality selection ML model, the method further includes selecting one or more of the output modalities based at least in part on the user input and the interaction context metadata. At one or more generative ML models, based at least in part on the user input, the method further includes computing one or more respective model outputs that respectively have the one or more selected output modalities. The method further includes outputting the one or more model outputs.

According to this aspect, the interaction context metadata may further include user interaction history data associated with one or more prior user inputs received at the multimodal ML system in one or more prior interaction sessions.

According to this aspect, based at least in part on the interaction context metadata and the one or more selected output modalities, the method may further include computing an event trigger associated with a model output of the one or more model outputs. The method may further include storing the model output and the event trigger in an output queue. The method may further include determining that the event trigger is satisfied. The method may further include outputting the model output in response to determining that the event trigger is satisfied.

According to this aspect, the method may further include receiving updated interaction context metadata while the model output is stored in the output queue. At the modality selection ML model, in response to receiving the updated interaction context metadata, the method may further include reselecting the one or more selected output modalities associated with the model output. At the one or more generative ML models, the method may further include recomputing the model output with the one or more reselected output modalities.

According to this aspect, at the modality selection ML model, the method may further include computing one or more respective output detail levels associated with the one or more selected output modalities. At the one or more generative ML models, the method may further include computing the one or more model outputs with the one or more respective output detail levels.

According to this aspect, the method may further include computing one or more modality indicator prompt fragments at the modality selection ML model. At the one or more generative ML models, the method may further include computing the one or more model outputs with the one or more selected output modalities respectively specified by the one or more modality indicator prompt fragments.

According to this aspect, at the modality selection ML model, the method may further include selecting the one or more generative ML models from among a plurality of generative ML models.

According to another aspect of the present disclosure, a computing system is provided, including one or more input devices, one or more output devices, and one or more processing devices. The one or more processing devices are configured to receive a user input via an input device of the one or more input devices. The one or more processing devices are further configured to receive interaction context metadata associated with the user input. The interaction context metadata includes an input modality of the user input and a plurality of output modalities of the one or more output devices. The interaction context metadata further includes user interaction history data associated with one or more prior user inputs received at the multimodal ML system in one or more prior interaction sessions. At a multimodal machine learning (ML) system, at a modality selection ML model, the one or more processing devices are further configured to select an output modality from among the plurality of output modalities based at least in part on the user input and the interaction context metadata. The selected output modality is a displayed text modality, a displayed image modality, an audio modality, or an application program control modality. At a generative ML model, based at least in part on the user input, the one or more processing devices are further configured to compute a model output that respectively has the selected output modality. The one or more processing devices are further configured to output the model output.

According to another aspect of the present disclosure, a computing system is provided, including one or more processing devices configured to receive a first user input at a user interface of a machine learning (ML) system. In response to receiving the first user input, the one or more processing devices are further configured to initiate a first model call to a first ML model included in the ML system. During execution of the first model call, the one or more processing devices are further configured to receive one or more second user inputs and perform one or more second model calls to a second ML model included in the ML system to compute one or more second model outputs based at least in part on the one or more second user inputs. The one or more processing devices are further configured to output the one or more second model outputs to the user interface. Subsequently to outputting the one or more second model outputs, the one or more processing devices are further configured to receive a first model output computed at the first ML model in response to receiving the first user input. The one or more processing devices are further configured to output the first model output to the user interface.

According to this aspect, the first ML model may be executed at a first server and the second ML model may be executed at a second server. The ML system may include a central router configured to transmit context data between the first ML model and the second ML model using a context protocol.

According to this aspect, the one or more processing devices may be further configured to transmit a partial result request to the first server prior to receiving the first model output. In response to transmitting the partial result request to the first server, the one or more processing devices may be further configured to receive a partial first model output at the central router. The one or more processing devices may be further configured to output the partial first model output to the user interface prior to outputting the first model output.

According to this aspect, the one or more processing devices may be further configured to compute at least a portion of the one or more second model outputs based at least in part on the partial first model output.

According to this aspect, the one or more processing devices may be further configured to, at the central router, receive a completion time estimate from the first server subsequently to initiating the first model call. The one or more processing devices may be further configured to output the completion time estimate to the user interface prior to outputting the first model output.

According to this aspect, the one or more processing devices may be further configured to transmit the first user input to the first server over the context protocol in a first context protocol session between the central router and the first server. The one or more processing devices may be further configured to disconnect the first context protocol session in response to transmitting the first user input to the first server. The one or more processing devices may be further configured to establish a second context protocol session between the central router and the first server subsequently to disconnecting the first context protocol session. At the central router, the one or more processing devices may be further configured to receive the first model output from the first server during the second context protocol session.

According to this aspect, the central router may remain connected to the user interface when the central router is disconnected from the first server.

According to this aspect, at the central router, the one or more processing devices may be further configured to transmit the one or more second model outputs to the first server over the context protocol. The first ML model may be configured to compute the first model output based at least in part on the one or more second model outputs.

According to this aspect, the computing system may further include memory storing an output queue associated with a first output modality. The one or more processing devices may be further configured to determine that the first model output has the first output modality, and that the output queue includes at least one prior model output. In response to determining that the first model output has the first output modality and that the output queue includes the at least one prior model output, the one or more processing devices may be further configured to store the first model output in the output queue. The one or more processing devices may be further configured to transmit the at least one prior model output to one or more output devices configured to output the first output modality. Subsequently to transmitting the at least one prior model output, the one or more processing devices may be further configured to transmit the first model output to the one or more output devices.

According to this aspect, the one or more processing devices may be configured to output the one or more second model outputs to the user interface in a second output modality that differs from the first output modality.

According to another aspect of the present disclosure, a method for use with a computing system is provided. The method includes receiving a first user input at a user interface of a machine learning (ML) system. In response to receiving the first user input, the method further includes initiating a first model call to a first ML model included in the ML system. During execution of the first model call, the method further includes receiving one or more second user inputs and performing one or more second model calls to a second ML model included in the ML system to compute one or more second model outputs based at least in part on the one or more second user inputs. The method further includes outputting the one or more second model outputs to the user interface. Subsequently to outputting the one or more second model outputs, the method further includes receiving a first model output computed at the first ML model in response to receiving the first user input. The method further includes outputting the first model output to the user interface.

According to this aspect, the first ML model may be executed at a first server and the second ML model may be executed at a second server. The ML system may include a central router configured to transmit context data between the first ML model and the second ML model using a context protocol.

According to this aspect, the method may further include transmitting a partial result request to the first server prior to receiving the first model output. In response to transmitting the partial result request to the first server, the method may further include receiving a partial first model output at the central router. The method may further include outputting the partial first model output to the user interface prior to outputting the first model output.

According to this aspect, the method may further include computing at least a portion of the one or more second model outputs based at least in part on the partial first model output.

According to this aspect, the method may further include, at the central router, receiving a completion time estimate from the first server subsequently to initiating the first model call. The method may further include outputting the completion time estimate to the user interface prior to outputting the first model output.

According to this aspect, the method may further include transmitting the first user input to the first server over the context protocol in a first context protocol session between the central router and the first server. The method may further include disconnecting the first context protocol session in response to transmitting the first user input to the first server. The method may further include establishing a second context protocol session between the central router and the first server subsequently to disconnecting the first context protocol session. The method may further include, at the central router, receiving the first model output from the first server during the second context protocol session.

According to this aspect, the central router may remain connected to the user interface when the central router is disconnected from the first server.

According to this aspect, at the central router, the method may further include transmitting the one or more second model outputs to the first server over the context protocol. At the first ML model, the method may further include computing the first model output based at least in part on the one or more second model outputs.

According to this aspect, the method may further include storing, in memory, an output queue associated with a first output modality. The method may further include determining that the first model output has the first output modality, and that the output queue includes at least one prior model output. In response to determining that the first model output has the first output modality and that the output queue includes the at least one prior model output, the method may further include storing the first model output in the output queue. The method may further include transmitting the at least one prior model output to one or more output devices configured to output the first output modality. Subsequently to transmitting the at least one prior model output, the method may further include transmitting the first model output to the one or more output devices.

According to another aspect of the present disclosure, a computing system is provided, including one or more processing devices configured to, at a machine learning (ML) system, exchange a plurality of asynchronous sets of conversational turns with a respective plurality ML models executed at corresponding servers. The ML system includes a central router configured to transmit context data between the plurality of ML models in a plurality of concurrently executed context protocol sessions of a context protocol. The plurality of conversational turns include a plurality of user inputs to the ML models and a respective plurality of model outputs computed at the ML models based at least in part on the context data. The context data includes at least a portion of the plurality of conversational turns. The one or more processing devices are further configured to output the plurality of asynchronous sets of conversational turns to a user interface.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
one or more input devices;
one or more output devices; and
one or more processing devices configured to:
receive a user input via an input device of the one or more input devices;
receive interaction context metadata associated with the user input, wherein the interaction context metadata includes:
an input modality of the user input; and
a plurality of output modalities of the one or more output devices;
at a multimodal machine learning (ML) system:
at a modality selection ML model, select one or more of the output modalities based at least in part on the user input and the interaction context metadata;
at one or more generative ML models, based at least in part on the user input, compute one or more respective model outputs that respectively have the one or more selected output modalities; and
output the one or more model outputs.

2. The computing system of claim 1, wherein the interaction context metadata further includes user interaction history data associated with one or more prior user inputs received at the multimodal ML system in one or more prior interaction sessions.

3. The computing system of claim 1, wherein the one or more processing devices are further configured to:
based at least in part on the interaction context metadata and the one or more selected output modalities, compute an event trigger associated with a model output of the one or more model outputs;
store the model output and the event trigger in an output queue;
determine that the event trigger is satisfied; and
output the model output in response to determining that the event trigger is satisfied.

4. The computing system of claim 3, wherein:
the computing system includes a plurality of output devices; and
the output queue is included among a plurality of device-specific output queues respectively associated with the output devices.

5. The computing system of claim 3, wherein the output queue is included among a plurality of modality-specific output queues respectively associated with the plurality of output modalities.

6. The computing system of claim 3, wherein the one or more processing devices are further configured to:
receive updated interaction context metadata while the model output is stored in the output queue;
at the modality selection ML model, in response to receiving the updated interaction context metadata, reselect the one or more selected output modalities associated with the model output; and
at the one or more generative ML models, recompute the model output with the one or more reselected output modalities.

7. The computing system of claim 3, wherein the one or more processing devices are configured to compute the event trigger at an output scheduling ML model included in the multimodal ML system.

8. The computing system of claim 1, wherein the one or more processing devices are further configured to:
at the modality selection ML model, compute one or more respective output detail levels associated with the one or more selected output modalities; and
at the one or more generative ML models, compute the one or more model outputs with the one or more respective output detail levels.

9. The computing system of claim 1, wherein the output modalities include a displayed text modality, a displayed image modality, an audio modality, and an application program control modality.

10. The computing system of claim 1, wherein the one or more processing devices are further configured to:
at the modality selection ML model, select two or more of the output modalities from among the plurality of output modalities; and
concurrently generate two or more model outputs at respective instances of the one or more generative ML models.

11. The computing system of claim 1, wherein the one or more processing devices are further configured to:
compute one or more modality indicator prompt fragments at the modality selection ML model; and
at the one or more generative ML models, compute the one or more model outputs with the one or more selected output modalities respectively specified by the one or more modality indicator prompt fragments.

12. The computing system of claim 1, wherein, at the modality selection ML model, the one or more processing devices are configured to select the one or more generative ML models from among a plurality of generative ML models.

13. A method for use with a computing system, the method comprising:
receiving a user input via an input device;
receiving interaction context metadata associated with the user input, wherein the interaction context metadata includes:
an input modality of the user input; and
a plurality of output modalities of one or more output devices included in the computing system;
at a multimodal machine learning (ML) system:
at a modality selection ML model, selecting one or more of the output modalities based at least in part on the user input and the interaction context metadata;
at one or more generative ML models, based at least in part on the user input, computing one or more respective model outputs that respectively have the one or more selected output modalities; and
outputting the one or more model outputs.

14. The method of claim 13, wherein the interaction context metadata further includes user interaction history data associated with one or more prior user inputs received at the multimodal ML system in one or more prior interaction sessions.

15. The method of claim 13, further comprising:
based at least in part on the interaction context metadata and the one or more selected output modalities, computing an event trigger associated with a model output of the one or more model outputs;
storing the model output and the event trigger in an output queue;
determining that the event trigger is satisfied; and
outputting the model output in response to determining that the event trigger is satisfied.

16. The method of claim 15, further comprising:
receiving updated interaction context metadata while the model output is stored in the output queue;
at the modality selection ML model, in response to receiving the updated interaction context metadata, reselecting the one or more selected output modalities associated with the model output; and
at the one or more generative ML models, recomputing the model output with the one or more reselected output modalities.

17. The method of claim 13, further comprising:
at the modality selection ML model, computing one or more respective output detail levels associated with the one or more selected output modalities; and
at the one or more generative ML models, computing the one or more model outputs with the one or more respective output detail levels.

18. The method of claim 13, further comprising:
computing one or more modality indicator prompt fragments at the modality selection ML model; and
at the one or more generative ML models, computing the one or more model outputs with the one or more selected output modalities respectively specified by the one or more modality indicator prompt fragments.

19. The method of claim 13, further comprising, at the modality selection ML model, selecting the one or more generative ML models from among a plurality of generative ML models.

20. A computing system comprising:
one or more input devices;
one or more output devices; and
one or more processing devices configured to:
receive a user input via an input device of the one or more input devices;
receive interaction context metadata associated with the user input, wherein the interaction context metadata includes:
an input modality of the user input; and
a plurality of output modalities of the one or more output devices; and
user interaction history data associated with one or more prior user inputs received at the multimodal ML system in one or more prior interaction sessions;
at a multimodal machine learning (ML) system:
at a modality selection ML model, select an output modality from among the plurality of output modalities based at least in part on the user input and the interaction context metadata, wherein the selected output modality is a displayed text modality, a displayed image modality, an audio modality, or an application program control modality;
at a generative ML model, based at least in part on the user input, compute a model output that respectively has the selected output modality; and
output the model output.
